(19) United States
(12) Patent Application Publication
(10) Pub. No.: US 2011/0208621 A1
(43) Pub. Date: Aug. 25, 2011

(54) Carbon Neutrality Management

(76) Inventors: Mitchell Bruce Feierstein, London (GB); Eric Vaughn-Flam, Westport, CT (US)

(21) Appl. No.: 12/711,238

(22) Filed: Feb. 23, 2010

(51) Int. Cl. G06Q 50/00; G06Q 10/00; G06Q 40/00

(52) U.S. Cl. 705/30; 705/317; 705/37

(57) ABSTRACT

A computer implemented method and system is provided for achieving carbon neutrality. A service provider creates an emission reduction project plan for generating carbon emission reduction credits. A verification entity verifies compliance of the emission reduction project and generates a verification report. A certification entity authenticates the verification report and generates a certification report. A custodial financial institution reviews documents and title to rights and deposits carbon emission reduction credits into the service provider's carbon credit trading account based on the certification report, the verification report, and title documentation. The service provider creates carbon neutral products with unique identifiers using the carbon emission reduction credits in the pre-created carbon credit trading account. An end user can retire the assigned carbon emission reduction credits by registering their details and the details of their purchase with the service provider using the unique identifier of a purchased carbon neutral product.

### BACKGROUND

Global warming is a phenomenon that results in an increase in the average temperature of the surface of the earth. According to the “Fourth Assessment Report on Climate Change 2007” by the United Nations Intergovernmental Panel on Climate Change (IPCC), global warming is likely caused by, for example, human activities that result in an increased concentration of greenhouse gases (GHGs) in the earth's atmosphere. GHGs are, for example, carbon dioxide (CO2), methane, perfluorocarbons, nitrous oxide, sulfur hexafluoride, and water vapor. The emission of GHGs by human activities contributes to global warming and climate change. GHGs other than carbon dioxide are typically measured by an internationally accepted measure, namely, the “carbon dioxide equivalent (CO2e)” that expresses the amount of global warming potential of a particular GHG in terms of the amount of carbon dioxide (CO2) that would have the same global warming effect. For example, one tonne of a GHG such as Hydrofluorocarbon-23 is equivalent to 14,800 tonnes of carbon dioxide (CO2). The equivalence is referred to as a carbon dioxide equivalent (CO2e). The CO2e of GHGs is commonly expressed by the United Nations IPCC as “billion metric tonnes of CO2e”, in industry as “million metric tonnes of CO2e”, and in vehicles as “grams of CO2e per kilometer”. A majority of the population is unaware of the adverse effects of global warming, for example, climate change, acid rain, etc. Accordingly, there is a long felt but unresolved need for promoting global warming awareness and reducing GHGs.

The tables below show the lifetimes and direct (except for CH4) 100-year global warming potentials (GWP) relative to CO2 for ozone-depleting substances and their replacements. These tables are from the Intergovernmental Panel on Climate Change (IPCC), Fourth Assessment Report (AR4), Working Group (WG) 1, Chapter 2, Changes in Atmospheric Constituents and in Radiative Forcing, Table 2.14, page 212, http://www.ipcc.ch/publications_and_data/publications_ipcc_fourth_assessment_report_wg1_report_the_physical_science_basis.htm

### Tables

The values for global warming potential in the AR4 WG1 technical summary reflect radiative forcing estimates and lifetimes that are improvements upon the values used in the IPCC Second Assessment Report (SAR) but which are still widely cited.

### Key Greenhouse Gases (GHG)

| | | | 100 yr | 100 yr |
|---|---|---|---|---|
| | | Lifetime | GWP | GWP |
| Designation or Name | Chemical formula | (years) | (SAR) | (AR4) |
| Carbon dioxide | CO₂ | Note¹ | 1 | 1 |
| Methane | CH₄ | 12² | 21 | 25 |
| Nitrous oxide | N₂O | 114 | 310 | 298 |

¹The CO2 response function used in this report is based on the revised version of the Bern Carbon Cycle Model using a background CO2 concentration value of 378 ppm. (See CO2 residence time graphs following)
²The perturbation lifetime for methane is 12 years as in the IPCC Third Assessment Report (TAR). The GWP for methane includes indirect effects from enhancements of ozone and stratospheric water vapor.

### Substances Controlled by the Montreal Protocol

| | | | 100 yr | 100 yr |
|---|---|---|---|---|
| | | Lifetime | GWP | GWP |
| Designation or Name | Chemical formula | (years) | (SAR) | (AR4) |
| CFC-11 | CCl₃F | 45 | 3,800 | 4,750 |
| CFC-12 | CCl₂F₂ | 100 | 8,100 | 10,900 |
| CFC-13 | CClF₃ | 640 | 10,800 | 16,400 |
| CFC-113 | CCl₂FCClF₂ | 85 | 4,800 | 6,130 |
| CFC-114 | CClF₂CClF₂ | 300 | 8,040 | 8,730 |
| CFC-115 | CClF₂CF₃ | 1,700 | 5,310 | 9,990 |
| Halon-1301 | CBrF₃ | 65 | 5,400 | 7,140 |
| Halon-1211 | CBrClF₂ | 16 | 4,750 | 575 |
| Halon-2402 | CBrF₂CBrF₂ | 20 | 3,680 | 503 |
| Carbon tetrachloride | CCl₄ | 26 | 1,400 | 1,400 |
| Methyl bromide | CH₃Br | 0.7 | 17 | 1 |
| Methyl chloroform | CH₃CCl₃ | 5 | 506 | 45 |
| HCFC-22 | CHClF₂ | 12 | 1,500 | 1,810 |
| HCFC-123 | CHCl₂CF₃ | 1.3 | 90 | 77 |
| HCFC-124 | CHClFCF₃ | 5.8 | 470 | 609 |
| HCFC-141b | CH₃CCl₂F | 9.3 | 2,250 | 220 |
| HCFC-142b | CH₃CClF₂ | 17.9 | 1,800 | 2,310 |
| HCFC-225ca | CHCl₂CF₂CF₃ | 1.9 | 429 | 37 |
| HCFC-225cb | CHClFCF₂CClF₂ | 5.8 | 2,030 | 181 |

### Hydrofluorocarbons

| | | | 100 yr | 100 yr |
|---|---|---|---|---|
| Designation | | Lifetime | GWP | GWP |
| or Name | Chemical formula | (years) | (SAR) | (AR4) |
| HFC-23 | CHF₃ | 270 | 11,700 | 14,800 |
| HFC-32 | CH₂F₂ | 4.9 | 650 | 675 |
| HFC-125 | CHF₂CF₃ | 29 | 2,800 | 3,500 |
| HFC-134a | CH₂FCF₃ | 14 | 1,300 | 1,430 |
| HFC-143a | CH₃CF₃ | 52 | 3,800 | 4,470 |
| HFC-152a | CH₃CHF₂ | 1.4 | 140 | 124 |
| HFC-227ea | CF₃CHFCF₃ | 34.2 | 2,900 | 3,220 |
| HFC-236fa | CF₃CH₂CF₃ | 240 | 6,300 | 9,810 |
| HFC-245fa | CHF₂CH₂CF₃ | 7.6 | 3,380 | 314 |
| HFC-365mfc | CH₃CF₂CH₂CF₃ | 8.6 | 2,520 | 241 |
| HFC-43-10mee | CF₃CHFCHFCF₂CF₃ | 15.9 | 1,300 | 1,640 |

### Perfluorinated Compounds

| | | | 100 yr | 100 yr |
|---|---|---|---|---|
| | | Lifetime | GWP | GWP |
| Designation or Name | Chemical formula | (years) | (SAR) | (AR4) |
| Sulphur hexafluoride | SF₆ | 3,200 | 23,900 | 22,800 |
| Nitrogen trifluoride | NF₃ | 740 | 12,300 | 20,700 |
| PFC-14 | CF₄ | 50,000 | 6,500 | 7,390 |
| PFC-116 | C2F₆ | 10,000 | 9,200 | 12,200 |
| PFC-218 | C₃F₈ | 2,600 | 7,000 | 8,830 |
| PFC-318 | c-C₄F₈ | 3,200 | 8,700 | 10,300 |
| PFC-3-1-10 | C₄F₁₀ | 2,600 | 7,000 | 8,860 |
| PFC-4-1-12 | C₅F12 | 4,100 | 6,510 | 13,300 |
| PFC-5-1-14 | C₆F1₄ | 3,200 | 7,400 | 9,300 |
| PFC-9-1-18 | C₁₀F1₈ | >1,000 d | >5,500 | >9,500 |
| trifluoromethyl sulphur | SF₅CF₃ | 800 | 13,200 | 21,200 |
| pentafluoride | | | | |

### Fluorinated Ethers

| | | Life- | 100 yr | 100 yr |
|---|---|---|---|---|
| Designation | | time | GWP | GWP |
| or Name | Chemical formula | (years) | (SAR) | (AR4) |
| HFE-125 | CHF₂OCF₃ | 136 | 13,800 | 8,490 |
| HFE-134 | CHF₂OCHF₂ | 26 | 12,200 | 1,960 |
| HFE-143a | CH₃OCF₃ | 4.3 | 2,630 | 230 |
| HCFE-235da2 | CHF₂OCHClCF₃ | 2.6 | 1,230 | 106 |
| HFE-245cb2 | CH₃OCF₂CHF₂ | 5.1 | 2,440 | 215 |
| HFE-245fa2 | CHF₂OCH₂CF₃ | 4.9 | 2,280 | 200 |
| HFE-254cb2 | CH₃OCF₂CHF₂ | 2.6 | 1,260 | 109 |
| HFE-347mcc3 | CH₃OCF₂CF₂CF₃ | 5.2 | 1,980 | 175 |
| HFE-347pcf2 | CHF₂CF₂OCH₂CF₃ | 7.1 | 1,900 | 175 |
| HFE-356pcc3 | CH₃OCF₂CF₂CHF₂ | 0.33 | 386 | 33 |
| HFE-449sl | C₄F9OCH₃ | 3.8 | 1,040 | 90 |
| HFE-569sf2 | C₄F9OC₂H₅ | 0.77 | 207 | 18 |
| HFE-43- | CHF₂OCF₂OC₂F₄OCHF₂ | 6.3 | 6,320 | 569 |
| 10pccc124 | | | | |
| HFE-236ca12 | CHF₂OCF₂OCHF₂ | 12.1 | 8,000 | 860 |
| HFE-338pcc13 | CHF₂OCF₂CF₂OCHF₂ | 6.2 | 5,100 | 460 |

### Perfluoropolyethers

| Designation | | Life- | 100 yr | 100 yr |
|---|---|---|---|---|
| or | | time | GWP | GWP |
| Name | Chemical formula | (years) | (SAR) | (AR4) |
| PFPMIE | CF₃OCF(CF₃)CF₂OCF₂OCF₃ | 800 | 7,620 | 12,400 |

### Hydrocarbons and Other Compounds—Direct Effects

| | | | 100 yr | 100 yr |
|---|---|---|---|---|
| Designation or | | Lifetime | GWP | GWP |
| Name | Chemical formula | (years) | (SAR) | (AR4) |
| Dimethylether | CH₃OCH₃ | 0.015 | 1 | <<1 |
| Methylene chloride | CH₂Cl₂ | 0.38 | 31 | 2.7 |
| Methyl chloride | CH₃Cl | 1.0 | 45 | 4 |

### CO2 Residence Time Graphs

The figure below shows the degree to which carbon dioxide (CO2) emissions persist in the atmosphere over time. The lifetime of a gas in the atmosphere is generally known as its “residence time”, but unlike other greenhouse gases, carbon dioxide does not undergo a simple decline over a single predictable timescale. Instead, the excess carbon is first diluted by the carbon cycle as it mixes into the oceans and biosphere (e.g. plants) over a period of a few hundred years, and then it is slowly removed over hundreds of thousands of years as it is gradually incorporated into carbonate rocks.³ ³ Global Warming Art, image created by Robert A. Rohde, http://www.globalwarmingart.com/wiki/Image:Carbon_Dioxide_Residence_Time_png

The United Nations Framework Convention on Climate Change (UNFCCC) is an international environmental treaty formed at the United Nations Conference for reducing emissions of GHGs. The UNFCCC comprises protocols, for example, the Kyoto Protocol. The Kyoto Protocol specifies limits or caps and reduction requirements on the emissions of GHGs on countries that have ratified the Kyoto Protocol. As used herein, the term “caps” refers to the maximum amount of carbon dioxide (CO2) emissions or CO2e emissions that could be emitted by the countries that have ratified the Kyoto Protocol. The Kyoto Protocol allows for the creation of an international “cap-and-trade” system that defines legally binding emission caps on countries that have ratified the Kyoto Protocol for reducing GHG emissions. Most of these countries set caps on the most carbon intense industrial sectors, for example, electricity generation and production of aluminum and cement. Under the UNFCCC, annex 1 countries must meet their obligations through national measures, for example, building wind farms, etc. The annex 1 countries comprise industrialized counties, for example, Australia, Austria, Belarus**, Belgium, Bulgaria, Canada, Croatia**, Czech Republic**, Denmark, Estonia, European Community, Finland, France, Germany, Greece, Hungary, Iceland, Ireland, Italy**, Japan, Latvia, Liechtenstein**, Lithuania, Luxembourg, Monaco**, Netherlands, New Zealand, Norway, Poland, Portugal, Romania, Russian Federation**, Slovakia**, Slovenia**, Spain, Sweden, Switzerland, Turkey**, Ukraine**, United Kingdom of Great Britain and Northern Ireland, and United States of America, wherein “**” represents parties for which there is a specific Conference of the Parties (COP) decision and/or Conference Meeting of the Parties (CMP) decision. The Kyoto Protocol offers the annex 1 countries flexible mechanisms, for example, emissions trading in Certified Emission Reduction (CER) units, Clean Development Mechanism (CDM) projects, Joint Implementation (JI) projects, etc. for meeting their obligations.

The CDM is an arrangement under the Kyoto Protocol that allows annex 1 countries with greenhouse gas reduction commitments and legally binding obligations to invest in emission reduction projects that generate quantifiable emission reductions that would not have happened in the normal business as usual scenario in non annex 1 countries, as an alternative to creating similar projects in their own countries that would similarly generate more expensive emission reductions in their own countries and would also not offer incentives to emerging economies to reduce CO2 or CO2e emissions. The non annex 1 countries comprise developing countries, for example, Afghanistan, Albania**, Algeria, Angola, Antigua and Barbuda, Argentina, Armenia**, Azerbaijan, Bahamas, Bahrain, Bangladesh, Barbados, Belize, Benin, Bhutan, Bolivia, Bosnia and Herzegovina, Botswana, Brazil, Brunei Darussalam, Burkina Faso, Burundi, Cambodia, Cameroon, Cape Verde, Central African Republic, Chad, Chile, China, Colombia, Comoros, Congo, Cook Islands, Costa Rica, Cuba, Cyprus, Cote d'Ivoire, Democratic People's Republic of Korea, Democratic Republic of the Congo, Djibouti, Dominica, Dominican Republic, Ecuador, Egypt, El Salvador, Equatorial Guinea, Eritrea, Ethiopia, Fiji, The former Yugoslav Republic of Macedonia, Gabon, Gambia, Georgia, Ghana, Grenada, Guatemala, Guinea, Guinea-Bissau, Guyana, Haiti, Honduras, India, Indonesia, Iran (Islamic Republic of), Israel, Jamaica, Jordan, Kazakhstan**, Kenya, Kiribati, Kuwait, Kyrgyzstan, Lao People's Democratic Republic, Lebanon, Lesotho, Liberia, Libyan Arab Jamahiriya, Madagascar, Malawi, Maldives, Mali, Malta, Marshall Islands, Mauritania, Mauritius, Mexico, Micronesia (Federated States of), Mongolia, Montenegro, Morocco, Mozambique, Myanmar, Namibia, Nauru, Nepal, Nicaragua, Niger, Nigeria, Niue, Oman, Pakistan, Palau, Panama, Papua New Guinea, Paraguay, Peru, Philippines, Qatar, Republic of Korea, Republic of Moldova**, Rwanda, Saint Kitts and Nevis, Saint Lucia, Saint Vincent and the Grenadines, Samoa, San Marino, Sao Tome and Principe, Saudi Arabia, Senegal, Serbia, Seychelles, Siena Leone, Singapore, Solomon Islands, South Africa, Sri Lanka, Sudan, Suriname, Swaziland, Syrian, Arab Republic, Tajikistan, Thailand, Timor-Leste, Togo, Tonga, Trinidad and Tobago, Tunisia, Turkmenistan**, Tuvalu, Uganda, United Arab Emirates, United Republic of Tanzania, Uruguay, Uzbekistan**, Vanuatu, Venezuela (Bolivarian Republic of), Vietnam, Yemen, Zambia, and Zimbabwe, wherein ** represents parties for which there is a specific conference of the parties decision and/or CMP decision. The annex 1 countries must first prove “additionality”. As used herein, the term “additionality” refers to proving that the GHG reduction was not achieved in any business as usual scenario and would not have occurred without the additional incentive from, for example, carbon finance, provided by a project proponent so they may own and resell the carbon emission reduction credits and/or title and/or any and all rights associated with the generation of these carbon emission reduction credits available generated from their project under the CDM guidelines, rules and methodologies and protocols.

The CDM's objective is to create GHG emission reductions while providing incentives to lesser developed countries to lower their GHG emissions and by attracting international investments in local emission reduction projects that allow net global GHG emissions to be reduced at a much lower overall cost by financing emissions reduction projects in non annex 1 countries where costs are lower than in annex 1 countries. The CDM executive board must approve and monitor all of the CDM projects and issue an appropriate number of carbon emission reduction credits to the annex 1 and/or non annex 1 country to certify that the annex 1 and/or non annex 1 country has reduced GHG emissions by a corresponding number of tonnes of CO2 or CO2e in all of the projects in the host country per year. The carbon emission reduction credits are issued by the CDM executive board after a lengthy process of registration, validation, verification, and certification as Certified Emission Reductions (CERs). For example, if an emission reduction project generates energy using wind power instead of burning coal, and the emission reduction project displaces 50 tonnes of CO2 or CO2e emissions per year, the emission reduction project has generated 50 CERs, since 1 CER is equivalent to a reduction of one tonne of CO2 or CO2e emissions. As used herein, one carbon emission reduction credit is equal to the reduction of one tonne of CO2 or CO2e emissions. Another term of art frequently utilized in the emission reductions space are Assigned Amount Units (AAU) where one properly monitored, verified and certified AAU would be equal to one tonne of CO2 or CO2e emission reductions.

Consider an example where a company in a non Annex I country, for example, Brazil switches from generating electricity at a coal fired power plant to generating the electricity with biomass resulting in a reduction of 100,000 tonnes per year of CO2 or CO2e. After the monitoring and verification process of this project has been completed, the CDM board may certify that this specific project activity of the company has reduced CO2 or CO2e emissions by 100,000 tonnes per year. The company is issued with 100,000 CERs. If an annex I country, for example, the United Kingdom has a legally binding compliance commitment to reduce its GHG emissions by 1 million tonnes of CO2 or CO2e each year, it purchases the 100,000 CERs from the Brazilian company and reduces its national carbon emission from 1 million tonnes per year to 900,000 tonnes per year, thereby making their legally binding compliance in accordance with their commitment made under the European Union Emission Trading System (EU ETS) easier to achieve.

The Kyoto protocol allows countries to join together in a cluster and treats the clustered countries as a single entity for trading carbon emission reduction credits and for compliance purposes as well as for transferring those carbon emission reduction credits, and/or for trading those carbon emission reduction credits with each or between each member country. Each country has a different cap and its own national inventory of CO2 or CO2e emissions. For example, for transferring regulated carbon emission reduction credits, for example CERs, the European Union (EU) may be treated as a single entity. The EU has adopted a “linking directive”. The linking directive allows EU companies to buy and sell carbon emission reduction credits generated from the CDM and the Joint Implementation (JI) for meeting their emission reduction obligations. For example, when a European company buys a Certified Emission Reduction (CER), the company will be allowed to use this CER credit to offset their obligation or cap under the law.

An Emission Reduction Unit (ERU) refers to the carbon emission reduction credit generated from a Joint Implementation (JI) project. One ERU is equal to one tonne of emission reduction of either CO2 or CO2e. Under the JI, an annex 1 country can invest in emission reduction projects in any other annex 1 country as an alternative to reducing CO2 or CO2e emissions domestically. In this way both the annex 1 countries can lower their cost of complying with their Kyoto obligations by investing in greenhouse gas reductions in an annex I country where reductions are cheaper, and then applying the carbon emission reduction credit for those reductions towards their commitment goal. The emission reduction projects under the JI produce carbon emission reduction credits, for example, Emission Reduction Units (ERUs)

The Voluntary Carbon Unit (VCU) refers to a carbon emission reduction credit generated from a voluntary emission reduction project, also referred to as Voluntary Emission Reductions (VER); both one VCU and one VER are each equivalent to one tonne of either CO2 or CO2e carbon emission reductions. The VER and VCU are emission reductions that have been generated outside of any required or monitored governmental and/or regulatory oversight and/or framework. As used herein, all named carbon emission reduction credits are delineated in terms of tonnes. A VER would refer to one tonne of carbon emission reductions, as would a VCU and a CER. For example, a person carrying out an emission reduction project or an activity that the person was not obliged to do so by law, but chose to do so voluntarily and where the project activity would not have occurred in the normal course of business, these emission reduction projects generate carbon emission reduction credits that would be considered candidates for the voluntary market. It is important to note, similar rigorous verification, certification, and other additional criteria apply to generation of the voluntary carbon emission reduction credits to ensure that genuine environmental benefits exist in these carbon emission reduction credits. Emission reductions may be generated and quantified from non-GHG generating activities, for example, wind power, solar power, energy efficiency, etc.

There is a long felt but unresolved need for individuals and organizations to mitigate the impact of their actions and activities which generate CO2 or CO2e by offsetting the amount of CO2 or CO2e they emit, directly and/or indirectly through their actions and activities to achieve net zero CO2 or CO2e emissions. This can be achieved by identifying, auditing, and quantifying the CO2 and CO2e emitted by the individual, organization or company, herein referred to as an “end user” and reconciling the measured amount of carbon emitted with an equivalent amount sequestered, or through use of carbon emission reduction offsets. The carbon reduction offsets are, for example, CERs, VERs, VCUs, JI credits, etc., provided the carbon reduction offsets are real, quantifiable, additional, permanent, verified, certified and stored in an industrial strength custodial registry, to preclude double counting of such credits. Carbon neutrality may be achieved, for example, through CO2 or CO2e emissions offsetting. CO2 or CO2e emissions offsetting is performed by, for example, an end user supporting carbon finance associated with projects which reduce the amount of CO2 or CO2e emitted into the atmosphere and thus generating carbon emission reduction credits, or with a direct purchase of carbon emission reduction credits via carbon trading, etc. Accordingly, there is a long felt but unresolved need for a carbon neutral product that will facilitate an end user to offset the end user's CO2 or CO2e emissions and thereby achieve carbon neutrality, that is, net zero CO2 or CO2e emissions.

Furthermore, the end user needs to perform a carbon audit for purposes of calculating the end user's carbon footprint, to ensure integrity in the system, and then transacting the carbon emission reduction credits based on the calculated and quantified amount of CO2 or CO2e emissions identified in the user's carbon footprint audit. As used herein, the term “carbon footprint” refers to the total GHG emissions, for example, the sum of scope 1 GHG emissions, scope 2 GHG emissions, and scope 3 GHG emissions, etc., generated and emitted into the atmosphere by an end user and/or by the activities of the end user. The activities of the end user are, for example, an event, air travel, operation of a motor vehicle, activities associated with the burning of fossil fuels, etc.

Scope 1 emissions are also known as direct emissions. Scope 1 emissions comprise emissions that occur on-site or from company-owned assets, for example, combustion of fuels, process emissions, refrigerant leakage, etc. These emissions are aggregated on a facility-level, with the company's vehicle fleet considered as one “facility.”

Scope 2 GHG emissions are also known as indirect emissions. Scope 2 emissions comprise emissions created directly on behalf of the company in the generation of electricity, or the delivery of energy via hot water or steam. The reason that the company generating the GHG emissions has to accept responsibility for such emissions is that the company has ultimate control over “turning on the light switch” and the company directly benefits from such emissions. Under California's Assembly Bill 32 (AB-32) Global Warming Solutions Act, many carbon intensive activities of companies such as utility companies are regulated based on all of their emissions, including those from electricity that is generated using fossil fuels and sold to consumers. This accounting may get slightly complicated and can result in double-counting in terms of the regulated utility emissions and non-regulated Scope 2 company-based emissions from their electricity use. However, regulating the aggregated emissions at a utility-level makes sense from a regulatory perspective and quantifying indirect GHG emissions from electricity use makes sense to individual companies because it is closely tied to cost-saving efforts from energy efficiency projects.

Scope 3 GHG emissions comprise, for example, emissions emitted from business travel and the shipping of goods (inbound and outbound), emissions from contracted activities (outsourced production, etc.), and emissions from resource extraction and product disposal. This cradle-to-grave analysis, while uncommon, is valuable. Most of the emissions that occur in a company's value chain are either upstream or downstream of the company. The benefit that a company obtains from calculating emissions sources throughout its supply chain, including scope 3 sources is clear. Because of the close correlation between emissions and fossil fuel use, understanding a company's upstream emissions helps the company to assess and understand its exposure to price risks associated with volatility in the global energy markets. Companies also need to understand their downstream emissions; emissions from the distribution, use, and disposal of products, etc.

Therefore, there is a long felt but unresolved need for an auditing platform which has the ability to calculate the carbon footprint of an end user by taking into account scope 1, scope 2, and scope 3 GHG emissions, as well as other CO2 or CO2e emissions generated by the users' activities. Furthermore, there is a need for a platform that allows an end user to purchase a product, or a certificate with an attached or embedded carbon emission reduction credit that allows the user to offset the CO2 or CO2e emissions that the end user or the end users actions or activities emit into the atmosphere to achieve carbon neutrality. Achieving carbon neutrality is also referred to as being carbon neutral. As used herein, the term “carbon neutrality” refers to achieving net zero CO2 or CO2e emissions by balancing the amount of carbon released with an equivalent amount sequestered or offset with carbon emission reduction credits.

Therefore, there is a need for a computer implemented method that enables the creation of a carbon neutral product which attaches or embeds carbon emission reduction credits to a consumer product or certificate for allowing the end user to achieve carbon neutrality. There is also a need for a computer implemented method and system that allows an end user to quantify and calculate the end user's carbon footprint and reconcile the amount of tonnes quantified and identified in the footprint analysis to allow the end user to purchase the carbon neutral product representing the corresponding amount of tonnes identified in the footprint analysis, thereby offsetting the end user's CO2 or CO2e emissions and thus allowing the end user to achieve carbon neutrality.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for creating carbon neutral products by conducting a carbon intensity audit and thereby assessing a carbon footprint of an end user and attaching corresponding quantities of carbon emission reduction credits to consumer products or certificates to allow an end user to achieve carbon neutrality. As used herein, the term “carbon footprint” refers to the sum of the total amount of carbon dioxide (CO2) and carbon dioxide equivalent (CO2e) emissions generated by the end user and all of the end user's activities. A carbon neutral product is a consumer product attached with carbon emission reduction credits. In the environmental arts, the terms “carbon dioxide (CO2)” and “carbon dioxide equivalent (CO2e)” are often abbreviated as “carbon”. As used herein, the term “carbon” is synonymous with and used interchangeably with the terms “carbon dioxide (CO2)” and “carbon dioxide equivalent (CO2e)”. For example, the phrase “carbon emission reduction credits or units” is synonymous with the phrase “carbon dioxide (CO2) emission and carbon dioxide equivalent (CO2e) emission reduction credits or units”. Similarly, the phrase “carbon emission reduction currency” is synonymous with the phrase “carbon dioxide (CO2) emission and carbon dioxide equivalent (CO2e) emission reduction currency”. One carbon emission reduction credit or unit is equal to the reduction of one tonne of CO2 or CO2e emissions. As used herein, the term “end user” refers to an individual, organization or company, which generates carbon dioxide (CO2) or carbon dioxide equivalent (CO2e) emissions by their actions and activities, for example, an activity performed during the course of manufacture or marketing of a product by the end user. Furthermore, the computer implemented method and system disclosed herein addresses the above stated need for a carbon neutrality management platform that allows an end user to quantify and calculate the end user's carbon footprint and reconcile the amount of tonnes quantified and identified in the footprint analysis so that the end user may then transact to purchase the carbon neutral products representing the corresponding amount of tonnes identified in the footprint analysis, thereby offsetting the end user's CO2 or CO2e emissions and thus allowing the end user to achieve carbon neutrality. The carbon neutrality management platform enables an end user to achieve carbon neutrality, that is, net zero CO2 or CO2e emissions by providing a mechanism for measuring CO2 or CO2e emissions, reducing those emissions, and offsetting residual emissions.

The computer implemented method of creating carbon neutral products comprises: a) providing an application software on a communication device of each of a service provider, a verification entity, a certification entity, and a custodial financial institution; b) creating a plan for an emission reduction project for creating and generating carbon emission reduction credits by a service provider using the application software; c) verifying compliance of the emission reduction project based on accepted standards found in, for example, the Clean Development Mechanism (CDM) approved emission reduction project protocols and methodologies, by the verification entity using the application software and generating a verification report, wherein the verification report is transmitted to the communication device of each of the certification entity, the service provider, and the custodial financial institution; d) authenticating the verification report based on standardized accepted certification criteria by the certification entity using the application software and generating a certification report, wherein the certification report is transmitted to the custodial financial institution who will act as the custodian of carbon emission reduction credits, and wherein generation of the certification report based on the authentication ensures compliance of the emission reduction project with the accepted standards and the standardized accepted certification criteria, for example, the Voluntary Carbon Standard or the Clean Development Mechanism, for generating carbon emission reduction credits that are real, quantifiable, additional, permanent, verified, and certified, and for proving that the service provider is entitled to rights associated with ownership of the carbon emission reduction credits; e) depositing carbon emission reduction credits into a pre-created carbon credit trading account of the service provider maintained by the custodial financial institution based on a review of title documentation, the verification report, and the certification report that ensures sole ownership of the carbon emission reduction credits and any rights associated with the ownership of the carbon emission reduction credits; f) assigning the carbon emission reduction credits available in the pre-created carbon credit trading account of the service provider to one or more consumer products by the service provider to create the carbon neutral products.

The service provider is entitled to the complete title and rights associated with the ownership of the carbon emission reduction credits or units. Furthermore, the service provider's entitlement of the complete ownership is verified by the verification entity and certified for authentication by the certification entity. The verification report and the certification report are then verified and reviewed as accurate by the custodial financial institution before the carbon emission reduction credits or units are deposited in either the pre-created carbon credit trading account or a carbon credit retirement account of the service provider. The service provider maintains the pre-created carbon credit trading account and the carbon credit retirement account with the custodial financial institution. The pre-created carbon credit trading account is used by the service provider to buy and sell the carbon emission reduction credits. The carbon emission reduction credits may be deposited in the pre-created carbon credit trading account as described above. Furthermore, the carbon emission reduction credits may be withdrawn from the pre-created carbon credit trading account. The service provider also maintains a carbon credit retirement account where the carbon emission reduction credits can be permanently retired after use by the end user once the end user directs the service provider to have the carbon emission reduction credits permanently retired by instructing the service provider to place the carbon emission reduction credits into the carbon credit retirement account of the service provider. As used herein, permanent retirement of the carbon emission reduction credits by the end user means that the end user has exhausted the carbon emission reduction credits and any rights associated with the carbon emission reduction credits accordingly. The permanently retired carbon emission reduction credits are not reusable once the service provider deposits the carbon emission reduction credits into the carbon credit retirement account maintained at the custodial financial institution. The permanently retired carbon emission reduction credits remain held in perpetuity in the service provider's carbon credit retirement account.

Each of the carbon neutral products with the attached or embedded carbon emission reduction credits has a unique identifier that represents a fixed denomination of the assigned carbon emission reduction credits. The service provider may also assign unique identifiers to one or more of the remaining carbon emission reduction credits available in the pre-created carbon credit trading account to create or generate supplementary carbon emission reduction credits if the end user wishes to offset more tonnes of CO2 or CO2e emissions than the end user has already purchased with the existing carbon neutral products. The service provider and the custodial financial institution reconcile the carbon neutral products with the assigned carbon emission reduction credits using the unique identifier. The unique identifier prevents double counting of the carbon emission reduction credits and the application software generates a complete audit trail that may be reconciled with the pre-created carbon credit trading account maintained in a custodial registry held at the custodial financial institution. The service provider can register the carbon neutral products and the supplementary carbon emission reduction credits with the custodial financial institution using the unique identifier. An end user who purchases one or more of the created carbon neutral products and the supplementary carbon emission reduction credits can permanently retire the carbon emission reduction credits using the unique identifiers associated with one or more of the purchased carbon neutral products or certificates and the purchased supplementary carbon emission reduction credits.

Disclosed herein is also a computer implemented method of enabling an end user to achieve carbon neutrality. The computer implemented method disclosed herein comprises: a) creating carbon neutral products and supplementary carbon emission reduction credits, wherein the carbon neutral products are created by attaching carbon emission reduction credits to consumer products and allowing the end users to purchase the carbon neutral products and supplementary carbon emission reduction credits which the service provider has available in a pre-created carbon credit trading account maintained by a custodial financial institution, wherein each of the carbon neutral products and the supplementary carbon emission reduction credits comprises a unique identifier that represents a fixed denomination of the carbon emission reduction credits; b) providing a carbon neutrality management platform for transacting the created carbon neutral products and the supplementary carbon emission reduction credits, wherein the carbon neutrality management platform comprises a product registry that stores a list of the created carbon neutral products and also a list of the supplementary carbon emission reduction credits available which the service provider may assign; c) calculating a carbon footprint of an end user by the carbon neutrality management platform; d) receiving a purchase request to neutralize the calculated carbon footprint from the end user by the carbon neutrality management platform and retrieving one or more of the list of carbon neutral products and the list of the supplementary carbon emission reduction credits from the product registry based on the purchase request; e) selecting one or more of the carbon neutral products and supplementary carbon emission reduction credits from the lists based on the corresponding number of tonnes that the end user wishes to offset, made available by the service provider for purchase by the end user from the service provider's existing or future inventory; f) transacting the selected carbon neutral products and the supplementary carbon emission reduction credits with the end user on the carbon neutrality management platform; g) receiving a retirement declaration request from the end user by the carbon neutrality management platform for declaring permanent retirement of the carbon emission reduction credits associated with the transacted carbon neutral products and the supplementary carbon emission reduction credits and directing that these tonnes be placed in the carbon credit retirement account; and h) comparing the calculated carbon footprint of the end user with the declared carbon emission reduction credits by the carbon neutrality management platform to determine the carbon neutrality achieved by the end user.

The end user requests for permanently retiring the carbon emission reduction credits associated with the transacted carbon neutral products and the supplementary carbon emission reduction credits using the retirement declaration request. The end user can permanently retire the carbon emission reduction credits by registering the carbon emission reduction credits associated with the transacted carbon neutral products and the supplementary carbon emission reduction credits with a carbon credit retirement account maintained by the custodial financial institution.

Disclosed herein is also a computer implemented method of transacting carbon emission reduction credits. The computer implemented method disclosed herein comprises: a) creating a carbon emission reduction currency represented by one or more carbon neutral products and supplementary carbon emission reduction credits, wherein the carbon emission reduction currency comprises a unique identifier, wherein the carbon emission reduction currency represents one of a fixed set of denominations of carbon emission reduction credits; and wherein the carbon emission reduction currency is associated with a secondary function; b) providing a carbon neutrality management platform that performs the steps of: c) identifying the carbon emission reduction currency based on the unique identifier d) determining one of the fixed set of denominations of carbon emission reduction credits associated with the identified carbon emission reduction currency; and e) enabling the end user to permanently retire the determined carbon emission reduction credits associated with the identified carbon emission reduction currency on the carbon neutrality management platform. The unique identifier is displayed on the carbon emission reduction currency. The service provider registers the unique identifier with a custodial financial institution that has the capability of issuing carbon emission reduction credits, tracking carbon emission reduction credits, and accepting retired carbon emission reduction credits. The carbon emission reduction currency is created by associating each of multiple consumer products and/or certificates with a fixed denomination of carbon emission reduction credits. The secondary function of the carbon emission reduction currency is associated with one or more utilities. The carbon neutrality management platform enables purchasing of the carbon emission reduction currency, selling the carbon emission reduction currency, trading the carbon emission reduction currency for an item of value, etc. The service provider provides the carbon emission reduction currency as a de facto clearly defined benchmark mechanism that creates a commoditized asset class of fungible carbon emission reduction credits or units. The carbon neutral products assigned with quantities of embedded carbon emission reduction credits serve as tradable commodities with standardized values that set a price and value for the carbon emission reduction credits or units. For example, a carbon neutral product such as a blue wrist band with embedded carbon emission reduction credits or units having a standardized value can be purchased by an end user at the set price.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIGS. 1A-1B illustrate a computer implemented method for creating carbon neutral products.

FIG. 2 illustrates a method of transacting carbon emission reduction credits.

FIG. 3 illustrates a computer implemented method for enabling an end user to achieve carbon neutrality using a carbon neutrality management platform.

FIG. 4 illustrates a computer implemented system for enabling an end user to achieve carbon neutrality.

FIG. 5 illustrates a process of generation and retirement of carbon emission reduction credits by a service provider.

FIG. 6 exemplarily illustrates the architecture of a computer system employed on the carbon neutrality management platform and the communication devices of the service provider, the verification entity, the certification entity, and the custodial financial institution for enabling an end user to achieve carbon neutrality.

### DETAILED DESCRIPTION OF THE INVENTION

A partial glossary of abbreviations used in the specification is tabulated below:

| | |
|---|---|
| GHG | Greenhouse gas |
| CO2 | Carbon Dioxide |
| CO2e | Carbon Dioxide Equivalent |
| IPCC | Intergovernmental Panel on Climate Change |
| UNFCCC | United Nations Framework Convention on Climate Change |
| COP | Conference of the Parties |
| CMP | Conference Meeting of the Parties |
| CER | Certified Emission Reduction |
| CDM | Clean Development Mechanism |
| JI | Joint Implementation |
| EU ETS | European Union Emission Trading System |
| EU | European Union |
| ERU | Emission Reduction Unit |
| VCU | Voluntary Carbon Unit |
| VER | Verified Emission Reduction |
| AB-32 | Assembly Bill-32 |
| VCS | Voluntary Carbon Standard |
| DOE | Department of Energy |
| DNV | Det Norske Veritas |
| SGS | Société Générale de Surveillance |
| CCB | Climate, Community & Biodiversity |
| WBCSD | World Business Council for Sustainable Development |
| WRI | World Resources Institute |
| CCAR | California Climate Action Registry |
| ISIN | International Securities Identification Number |
| CUSIP | Committee on Uniform Securities Identification Procedures |
| PES | Payment for Environmental Services |
| PDD | Project Design Document |
| PIN | Project Information Note |

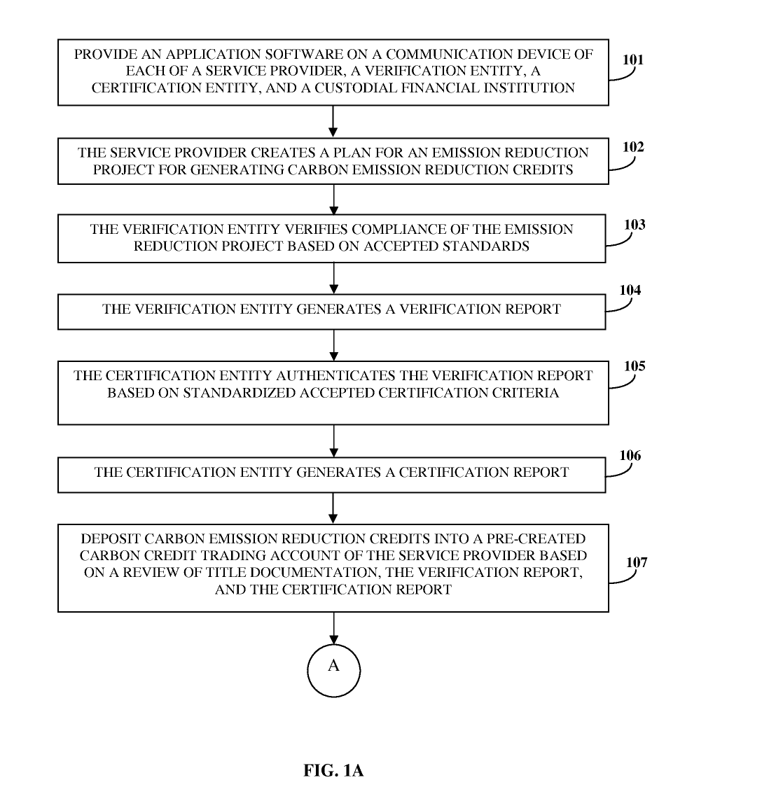

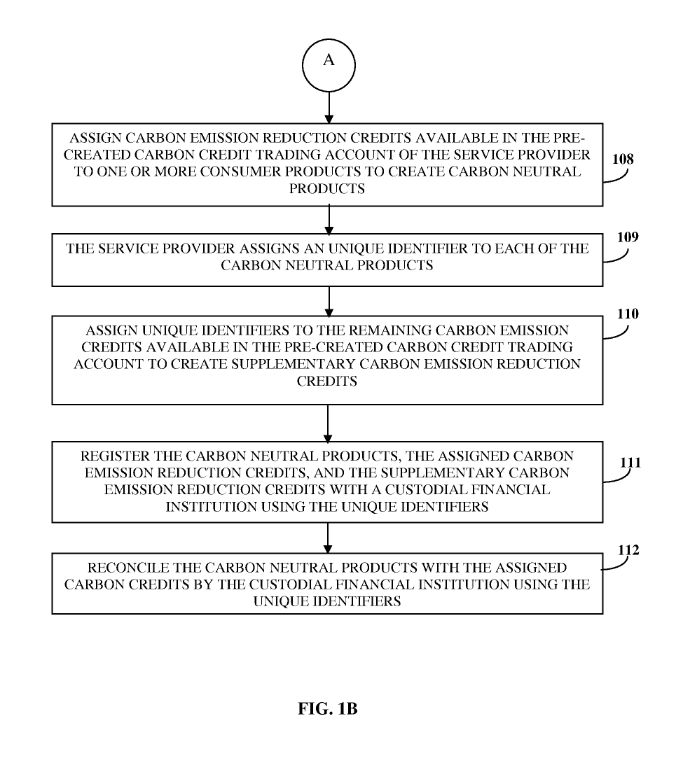

FIGS. 1A-1B illustrate a computer implemented method for creating carbon neutral products. As used herein, the term “carbon neutral product” refers to any item or consumer product, for example, a toy, a wrist band, a car, a piece of jewelry, a T-shirt, credit or debit cards, carbon credit top up cards, a certificate, a card, etc. with attached carbon emission reduction credits. As used herein, the term “carbon” is synonymous with and used interchangeably with the terms “carbon dioxide (CO2)” and “carbon dioxide equivalent (CO2e)”. For example, the phrase “carbon emission reduction credits” is synonymous with “carbon dioxide (CO2) emission and carbon dioxide equivalent (CO2e) emission reduction credits”. Similarly, the phrase “carbon emission reduction currency” is synonymous with “carbon dioxide (CO2) emission and carbon dioxide equivalent (CO2e) emission reduction currency”. Also, as used herein, the term “carbon emission reduction credit” refers to a permit that allows an end user to emit and offset one tonne of greenhouse gas (GHG) emissions referred to as either as tonnes of carbon dioxide (CO2), and/or as tonnes of carbon dioxide equivalent (CO2e). As used herein, one carbon emission reduction credit or unit is equal to one tonne of carbon emission reductions and the terms “units” and “credit units” are generally the plural of and interchangeable with the term “credits”.

Also, as used herein, the term “end user” refers to an individual, organization or company, which generates CO2 or CO2e emissions by their actions and activities, for example, activities performed during the course of manufacture or marketing of a product by the end user. Also, as used herein, the term “carbon neutrality” refers to achieving net zero CO2 or CO2e emissions by balancing a measured amount of carbon released with an equivalent amount sequestered or offset with carbon emission reduction credits. The carbon neutrality concept may be extended to include other GHGs, for example, methane, nitrous oxide, hydro fluorocarbons, perfluorocarbons, and sulphur hexafluoride water vapor, etc., measured in terms of their CO2e.

An application software is provided 101 on a communication device of each of a service provider, a verification entity, a certification entity, and a custodial financial institution. The communication device is, for example, a personal computer, a laptop, a mobile phone, a personal digital assistant (PDA), a smart phone, etc. Furthermore, the mobile phone is, for example, a BlackBerry® device of Research In Motion Limited, an iPhone® of Apple Inc., etc. The PDA and smart phones can employ mobile operating systems, for example, Android® mobile operating system of Google Inc, Symbian® mobile operating system of Symbian Foundation, etc. As used herein, the “service provider” refers to a company, an organization, or an individual that wishes to create emission reduction projects that generate carbon emission reduction credits and that is involved in the creation of the carbon neutral products. The carbon emission reduction credits may be, for example, a Certified Emission Reduction (CER) units, Voluntary Carbon Units (VCUs), a gold standard emission reduction unit, Emission Reduction Units (ERUs), Verified Emission Reductions (VER), etc. A CER unit is a carbon emission reduction credit generated from a Clean Development Mechanism (CDM) project where each of these carbon emission reduction credits is equal to one tonne of carbon emission reduction.

The service provider creates 102 a plan for an emission reduction project for generating carbon emission reduction credits using the application software on the service provider's communication device and transmits the emission reduction project plan to a verification entity via a communication network. The communication network is, for example, a WiFi communication network, a general packet radio service (GPRS) network, a mobile telecommunication network, a local area communication network, an internet connection network, a Bluetooth™ communication network, an infra red communication network, etc. As used herein, the term “emission reduction project” refers to an emission reduction project that creates or generates carbon emission reduction credits. The emission reduction project should be compliant with robust methodologies and protocols, for example, the Clean Development Mechanism (CDM), the Joint Implementation (JI), Voluntary Carbon Standard (VCS) or verified emission reduction (VER) that can demonstrate additionally, and other gas emission reduction protocols, etc. The compliance assures that the generated carbon emission reduction credits are real, permanent, quantifiable and not business as usual emission reductions.

The verification entity verifies 103 compliance of the emission reduction project based on accepted standards using the application software on the verification entity's communication device and generates 104 a verification report. The verification entity also verifies whether the service provider is entitled to complete ownership of the generated carbon emission reduction credits. The accepted standards are used to prove that the emission reduction projects are in compliance with the methodologies contained in that standard applicable to that emission reduction project and used by the verification entity to assess and ensure the additionality and genuine environmental benefits of the emission reduction projects. As used herein, the term “additionality” refers to proving that the GHG reduction was not achieved by the end user as a routine or usual scenario or operation and would not have occurred without the additional incentive from, for example, carbon finance, provided by the emission reduction project so that the service provider may own and resell the carbon emission reduction credits and/or title and/or any and all rights associated with the carbon emission reduction credits generated from their emission reduction project under the CDM guidelines, rules and methodologies and protocols. The verification entity is an independent third-party that is a qualified, recognized, and a financially and legally accountable entity, which also has documented experience in verifying the compliance of emission reduction projects and has the required scientific and technical experience to review and determine the accuracy of monitoring of GHG emission reductions projects. The verification entity is, for example, a designated operational entity approved and appointed by the CDM executive board. Examples of Designated Operational Entities (DOEs) designated and approved as verifiers and certifiers by the United Nations Framework Convention on Climate Change (UNFCCC) board, are, for example, the Det Norske Veritas (DNV) Société Générale de Surveillance (SGS) verification group, etc. The DOE validates and/or certifies and/or verifies and subsequently requests registration of a proposed emission reduction project.

As used herein, the accepted standards used for generation of the verification and certification reports are any robust GHG mitigation standards which demonstrate that the carbon emission reduction credits or units generated from the emission reduction projects that are carefully monitored are also held in a custodial registry that is maintained at a custodial financial institution. All of the carbon emission reduction credits or units held in custodial registry must be real, permanent, quantifiable, verified, certified, and additional. The custodial registry, for example, the Voluntary Carbon Registry, is maintained by a custodial financial institution, for example, The Bank of New York, New York, USA. The accepted standards for carbon emission reduction credits or units generated under voluntary programs are, for example, detailed in the following standards: the Voluntary Carbon Standard (VCS), the Gold Standard, the Climate, Community & Biodiversity (CCB) standard, the Green-e standard, Plan Vivo, the Climate Neutral Network, Greenhouse Friendly, World Business Council for Sustainable Development (WBCSD)/World Resources Institute (WRI) protocol, California Climate Action Registry (CCAR), VER+standard, the Voluntary Carbon Standard version 1, etc. The Voluntary Carbon Standard (VCS) refers to a quality standard for the measurement and recognition of Verified Emission Reductions (VERs) created for voluntary use by a service provider, for example, a corporation, an organization, and individuals. Verified Emission Reductions are equal to Voluntary Emission Reductions (VERs) which are also equal to Voluntary Carbon Units (VCUs). The Voluntary Carbon Standard (VCS) is a set of global quality criteria for the verified emission reduction (VER) market. The VCS is maintained and reviewed on a regular basis by a VCS steering committee. The VCS steering committee comprises climate change experts who support the standardization of the global voluntary carbon markets which ensure that all the carbon emission reduction credits generated provide genuine environmental benefits. Plan Vivo is a set of standards used to develop and register Payment for Environmental Services (PES) projects in developing countries. PES projects comprise, for example, afforestation and agro-forestry, forest conservation, restoration and avoided deforestation, and are implemented by small-holders or communities on their own land, or land that they have and can prove user rights and ownership, etc. The verification report verifies that the carbon emission reduction credits are compliant with additional protocols and methodologies and that the emission reduction offset credits provide genuine environmental benefits as well as the additionality of the emission reduction project. The verification report is transmitted to the communication device of each of the certification entity, the service provider, and the custodial financial institution via the communication network.

The certification entity is, for example, a designated operational entity approved and appointed by the CDM executive board. The certification entity authenticates 105 the transmitted verification report based on standardized accepted certification criteria using the application software on the certification entity's communication device. The certification entity also checks the accuracy of the transmitted verification report by verifying that the emission reduction project complies with, for example, guidelines set forth by the World Business Council for Sustainable Development (WBCSD)/World Resources Institute (WRI) GHG project protocol and certifies the carbon emission reduction offsets. The certification entity then generates 106 a certification report. The certification report comprises a carbon unit certification statement in terms of tonnes of either CO2 or CO2e. The carbon unit certification statement comprises the amount of carbon emission reduction credits generated by the emission reduction project.

The verification report, the certification report, and the emission reduction project plan are transmitted to a custodial financial institution that has financial and legal accountability via the communication network. The custodial financial institution is, for example, The Bank of New York, New York, USA, or another carbon emission reduction credit custodian. The custodial financial institution verifies the title and/or rights associated with the generation of the carbon emission reduction credits as well as the validity of the transmitted verification report, the authenticity of the transmitted certification report and the correctness and need for the transmitted emission reduction project plan. The verification is performed by, for example, checking that the emission reduction project complies with the methodologies and protocols specified in the accepted standards and standardized accepted certification criteria, for example, the Voluntary Carbon Standard (VCS), to ensure that each carbon emission reduction credit is real, permanent, quantifiable, verified, certified, and additional. The verification entity ensures compliance of all project details within the parameters set forth in the methodologies and protocols contained in the standard, for example, the Voluntary Carbon Standard (VCS) under which all of the project details and the emission reduction project plan are carefully evaluated and confirmed for additionality, permanence of the reductions, checking for proper project title, rights, and ownership details, etc. The verification further proves that the service provider is entitled to rights associated with ownership of the carbon emission reduction credits.

After receipt, review, and a final check of documentation including the title documentation, the verification report, and the certification report that ensures sole ownership of the carbon emission reduction credits and any rights associated with the ownership of the carbon emission reduction credits by the service provider, the custodial financial institution deposits the carbon emission reduction credits into a pre-created carbon credit trading account of the service provider. The service provider maintains the pre-created carbon credit trading account with the custodial financial institution. The carbon emission reduction credits may be deposited in the pre-created carbon credit trading account. Furthermore, the carbon emission reduction credits may be withdrawn from the pre-created carbon credit trading account. The amount of carbon emission reduction credits stated in the carbon unit certification statement is deposited 107 into the pre-created carbon credit trading account belonging to the service provider which is maintained by the custodial financial institution. The pre-created carbon credit trading account is used by the service provider to buy and sell the carbon emission reduction credits. The service provider must appoint a recognized custodial financial institution that acts a legally and financially accountable custodial agent. The service provider is entitled to the complete title and rights associated with the ownership of the carbon emission reduction credits. Furthermore, the service provider's entitlement of the title, rights, and complete ownership of the carbon emission reduction credits is verified by the verification entity, certified by the certification entity, and reviewed by the legally and financially accountable custodial financial institution.

As disclosed above, the carbon emission reduction credits are generated through emission reduction projects. Based on the compliance of the emission reduction projects with accepted standards and standardized accepted certification criteria, different names of carbon emission reduction credits are used. The accepted standards and the standardization certification criteria comprise protocols and methodologies that demonstrate that the emission reductions generated are real, permanent, quantifiable, verified and certified and additional. The different names of carbon emission reduction credits are, for example, certified carbon emission reduction credits, voluntary carbon emission reduction credit units, gold standard carbon emission reduction credit units, carbon emission reduction credit units, verified carbon emission reduction credit units, etc.

The service provider assigns 108 the carbon emission reduction credits available in the pre-created carbon credit trading account of the service provider to one or more consumer products to create the carbon neutral products. The carbon neutral product is, for example, a certificate, a toy, a wrist band, a car, a piece of jewelry, a T-shirt, credit or debit cards, carbon credit top up cards, etc. made by the service provider. The service provider then assigns 109 a unique identifier to each of the carbon neutral products. The unique identifier is, for example, a unique serial number that represents a fixed denomination of the assigned carbon emission reduction credits corresponding to that carbon neutral product. The unique identifier may be similar to a securities identifier such as an International Securities Identification Number (ISIN) or a Committee on Uniform Securities Identification Procedures (CUSIP) number.

The service provider will have many other carbon emission reduction credits that may be used for offsetting future emission reductions contained within that pre-created carbon credit trading account that have their own unique identifiers. The service provider assigns 110 unique identifiers to the remaining carbon emission reduction credits available in the pre-created carbon credit trading account of the service provider to create supplementary carbon emission reduction credits which the service provider may sell to end users. The end users are, for example, individuals, organizations or companies, which generate CO2 or CO2e emissions by their actions and activities during the course of manufacture or marketing of a product. The end users may wish to buy supplementary carbon emission reduction credits to offset their CO2 or CO2e emissions and to achieve carbon neutrality. As used herein, supplementary carbon emission reduction credits refer to top up carbon emission reduction credits. For example, an end user may purchase one or more supplementary carbon emission reduction credits to recharge a carbon neutral product, once the original carbon emission reduction credits representing particular tonnes of GHGs have been permanently transferred into a carbon credit retirement account maintained by the custodial financial institution. The pre-created carbon credit trading account and the carbon emission reduction credit retirement account are both maintained in a custodial registry within the custodial financial institution.

The service provider maintains the carbon credit retirement account with the custodial financial institution where the carbon emission reduction credits remain in perpetuity after use by the end user once the end user directs the service provider to have the carbon emission reduction credits corresponding to the unique identifiers which the end user purchased from the service provider in the form of the carbon neutral products permanently retired. Both of the pre-created carbon credit trading account and the carbon credit retirement account containing the deposited and retired carbon emission reduction credits respectively are created at the custodial financial institution as carbon emission reduction credit custody accounts in the name of the service provider at the custodial financial institution.

The service provider registers 111 the carbon neutral products and the supplementary carbon emission reduction credits with a custodial registry maintained by the custodial financial institution using the unique identifiers for reconciliation of the assigned carbon emission reduction credits with the custodial financial institution. The registration ensures that the carbon emission reduction credits are not double counted and a clear audit trail exists. The custodial financial institution reconciles 112 the carbon neutral products with the assigned carbon emission reduction credits using the unique identifiers, and also reconciles the supplementary carbon emission reduction credits. An end user who purchases one or more of the created carbon neutral products and the supplementary carbon emission reduction credits may at any time notify the service provider to permanently retire the assigned carbon emission reduction credits using the unique identifier associated with the purchased carbon neutral product and/or supplementary carbon emission reduction credits thereby offsetting the end user's CO2 or CO2e emissions. As used herein, permanent retirement of the carbon emission reduction credits by the end user means that the end user has exhausted the carbon emission reduction credits and accordingly, the permanently retired carbon emission reduction credits are not reusable. The permanently retired carbon emission reduction credits are held in perpetuity in the service provider's carbon credit retirement account.

Consider an example where a service provider, for example, a company, wishes to generate carbon emission reduction credits, for example, Voluntary Carbon Units (VCUs). The service provider creates a carbon emission reduction credit Project Design Document (PDD), or a carbon emission reduction credit Project Information Note (PIN) for the generation of carbon emission reduction credits using the application software provided on the service provider's communication device. The emission reduction project is, for example, building a wind mill. The service provider then has to establish additionality and compliance with the methodologies and protocols contained in the Voluntary Carbon Standard (VCS). The emission reduction project will then be evaluated by the verification entity, for example, a designated operational entity, and found to either comply or not comply with the rules, guidelines, and methodologies contained in the VCS. To move the emission reduction project forward, the service provider produces documentation pertaining to the emission reduction project that proves that the emission reduction project activity generates carbon emission reduction credits which provide genuine environmental benefits that are additional and comply with the standards under which they are to be verified and certified as compliant by the verification entity.

The emission reduction project plan, for example, the PDD or the PIN is then transmitted from the service provider's communication device to the verification entity's communication device via a communication network. The verification entity visits and examines the project site of the service provider and reviews and examines all the monitoring procedures and all other relevant details in determining whether the emission reduction project activity generates carbon emission reduction credits which provide genuine environmental benefits and are generated in compliance with the relevant standards. When the service provider builds a wind farm, carbon emission reduction credits of greenhouse gases may be created by displacing electricity that would have been generated from a coal fired power plant, if the wind mill project activity had not occurred. The verification entity evaluates every detail of the emission reduction project's activities and assures that the emission reduction project is in compliance with the accepted standard.

The verification entity reviews the monitoring reports and other appropriate documentation based on, for example, VCS methodologies and protocols and validates the emission reduction project as a VER project where it is in compliance with the VCS rules and guidelines, and subsequently requests registration of the VER project. The verification entity generates a verification report and transmits the verification report to the certification entity's communication device. The certification entity is, for example, another designated operational entity. The certification entity checks the authenticity of the transmitted verification report based on compliance with the VCS rules and guidelines and generates a certification report. The certification report comprises a VCU certification statement. The VCU certification statement is a statement of assurance made by the certification entity that the related VCU emission reduction project complies with the Voluntary Carbon Standard. The certification report allows the service provider to be credited with, for example, 100,000 VCUs which would also represent 100,000 tonnes of carbon emission reduction credits.

The certification entity transmits the title, verification report, and the certification report to a custodial financial institution, for example, The Bank of New York, New York, USA. The Bank of New York reviews all the documentation and credits 100,000 VCUs to the service provider's pre-created carbon credit trading account and assigns a unique serial number to each of the VCUs generated by the emission reduction project. The service provider then assigns one or more of the credited VCUs to a consumer product, for example, a toy, to create a carbon neutral toy that can be sold to an end user by the service provider. The end user may buy the carbon neutral toy to offset CO2 or CO2e emissions generated by the end user's activities in the manufacture and marketing of the toy and to achieve carbon neutrality. The service provider assigns a unique serial number to the carbon neutral toy. The Bank of New York and the service provider assign unique identifiers and reconcile these numbers with each other and to avoid double counting. The remaining carbon emission reduction credits available in the pre-created carbon credit trading account of the service provider are provided with other unique identifiers allowing for the creation and tracking of supplementary carbon emission reduction credits that can be sold to end users. The end user can purchase supplementary carbon emission reduction credits to offset CO2 or CO2e emissions generated by the end user or the activities of the end user and to achieve carbon neutrality. The service provider then registers the carbon neutral toy with the unique identifier and the supplementary carbon emission reduction credits with the custodial registry maintained by The Bank of New York.

Consider another example where a service provider, for example, a toy company, wishes to manufacture a carbon neutral product, for example, a plush toy called “Save The Planet Sammy”. An emission reduction project plan is created that accounts for the CO2 and CO2e emissions generated by all the processes surrounding the creation and delivery of the plush toy. The emission reduction project plan comprises the product details, for example, the process of manufacturing the plush toy and all of the associated CO2 or CO2e emissions involved in the manufacture, CO2 or CO2e emissions involved in the packaging of the plush toy, CO2 or CO2e emissions involved in the distribution and sale of the plush toy, CO2 or CO2e emissions involved in the consumption and disposal of the plush toy by an end user, etc. The plush toy is manufactured by the toy company taking into account the CO2 or CO2e emissions associated with, for example, growing of materials, for example, cotton for the manufacture of the plush toy, harvesting and processing of the materials involved in the manufacture of the plush toy, etc.

The plush toy is manufactured taking into account the CO2 or CO2e emissions associated with the manufacture of the plush toy, the packaging of the plush toy, the materials involved in the packaging of the plush toy, for example, capsules, labels, glass, plastic, shipping, etc. The CO2 or CO2e emissions involved in the transportation and sales comprises, for example, the CO2 or CO2e emissions associated with distribution of the plush toy, transport of the plush toy, marketing of the plush toy, wholesaling of the plush toy, retailing and sale of the plush toy, etc. The CO2 or CO2e emissions involved in the consumption and disposal of the plush toy comprises, for example, the CO2 or CO2e emissions associated with, for example, purchase of the plush toy, storage purchase of the plush toy, recycling of the plush toy, disposal of the plush toy, etc.

The emission reduction project plan is approved and matched with, for example, 100,000 carbon emission reduction credits that have previously been verified, certified, and credited in the pre-created carbon credit trading account of the service provider. The service provider will then assign, for example, 10 carbon emission reduction credits to each of the 5000 manufactured plush toys and assigns a unique identifier to each of the plush toys. The service provider also assigns unique identifiers to the remaining 50,000 carbon emission reduction credits and creates 50,000 supplementary carbon emission reduction credits. The unique identifiers are reconciled with the custodial financial institution, for example, The Bank of New York, New York, USA, to prevent double-counting. The supplementary carbon emission reduction credits may be purchased as top up carbon emission reduction credits by existing end users. As used herein, “top up carbon emission reduction credits” refer to additional carbon emission reduction credits that can be purchased by the end user to achieve carbon neutrality. Consider an example where an end user registers details with the service provider and the unique identifier which quantifies the carbon emission reduction credits embedded or attached to a purchased carbon neutral product. The end user then requests the carbon neutrality management platform to conduct a carbon audit to calculate the end user's carbon footprint. On completion of the carbon audit, if the sum of CO2 or CO2e emissions generated by the end user is greater than the amount of tonnes represented by the carbon emission reduction credits embedded or attached to the purchased carbon neutral product, the carbon neutrality management platform gives the end user an option to purchase top up carbon emission reduction credits to achieve zero CO2 or CO2e emissions or carbon neutrality. Similarly, if the end user wishes to offset any further or future CO2 or CO2e emissions generated by the end user or the activities of the end user, the end user may do so using the top up carbon emission reduction credits. The plush toys with the associated unique identifiers and the supplementary carbon emission reduction credits are registered with a custodial registry maintained by the custodial financial institution.

In an example, a first service provider may purchase carbon emission reduction credits from an emission reduction project, for example, ABC Wind farm project, executed by a second service provider. Both the first service provider and the second service provider hold pre-created carbon credit trading accounts at the custodial financial institution. The pre-created carbon credit trading accounts are held in a legally and financially accountable custodial registry within the custodial financial institution. The first service provider may purchase carbon emission reduction credits that are real, quantifiable, permanent, accountable, verified and certified as VCUs by virtue of being in the custodial registry, from the second service provider. The purchased carbon emission reduction credits are transferred from the pre-created carbon credit trading account of the second service provider to the pre-created carbon credit trading account of the first service provider. In addition, the first service provider may initiate emission reduction projects that generate carbon emission reduction credits that are real, quantifiable, permanent, accountable, verified and certified. An end user may purchase carbon neutral products and supplementary carbon emission reduction credits to reduce the end user's carbon footprint. The end user may provide a retirement declaration request to the first service provider upon usage of the purchased carbon emission reduction credits. The first service provider may also hold a carbon credit retirement account in the custodial registry within the custodial financial institution. The retirement declaration request declares that the end user has exhausted the carbon emission reduction credits and accordingly, the permanently retired carbon emission reduction credits are not reusable. The permanently retired carbon emission reduction credits are registered in the first service provider's carbon credit retirement account.

In an embodiment, the service provider creates the carbon neutral product and the supplementary carbon emission reduction credits as a carbon emission reduction currency. The end user can trade the carbon emission reduction currency for an item of value. The carbon emission reduction currency comprises a unique identifier displayed on the carbon emission reduction currency which may be traded or registered and permanently retired. Each carbon emission reduction currency represents one of a fixed set of denominations of carbon emission reduction credits. Each carbon emission reduction currency is associated with a secondary function associated with one or more utilities. Consider an example wherein the carbon neutral products that represent the carbon emission reduction currency are wrist bands of multiple colors. The service provider assigns, for example, 100 carbon emission reduction credits to a blue colored wrist band, 50 carbon emission reduction credits to a yellow colored wrist band, etc. The carbon emission reduction currency has a secondary function where the wrist band may be worn as an accessory by the end user. The service provider provides the carbon emission reduction currency as a de facto clearly defined benchmark mechanism that creates a commoditized asset class of fungible carbon emission reduction credits or units. The carbon neutral products assigned with quantities of embedded carbon emission reduction credits serve as tradable commodities with standardized values that set a price and value for the carbon emission reduction credits or units. For example, a carbon neutral product such as a blue wrist band with embedded carbon emission reduction credits or units having a standardized value can be purchased by an end user at the set price.

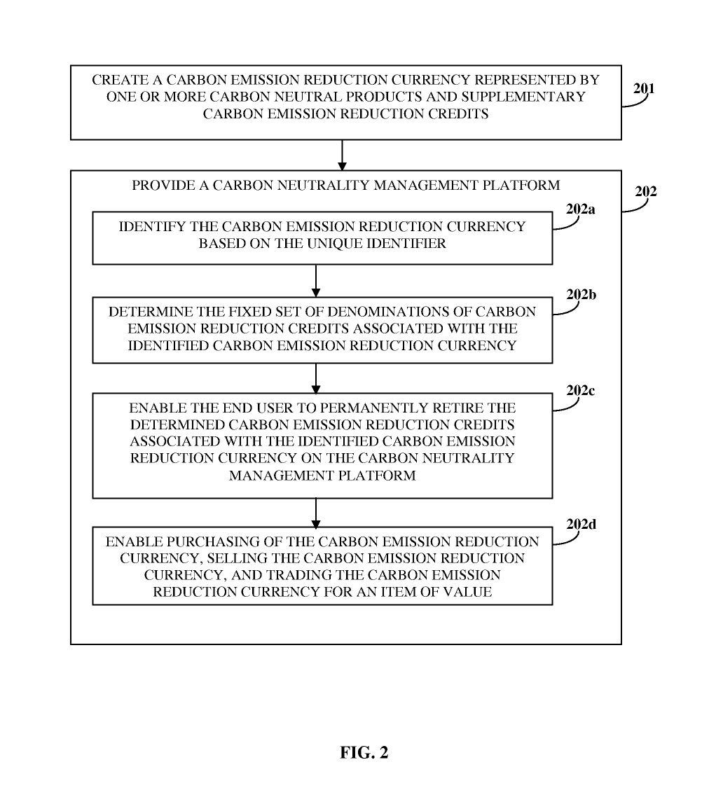

FIG. 2 illustrates a method of transacting carbon emission reduction credits. A service provider creates 201 a carbon emission reduction currency represented by one or more carbon neutral products and supplementary carbon emission reduction credits. The carbon emission reduction currency is created by associating each of multiple consumer products with a fixed denomination of the carbon emission reduction credits. A carbon neutrality management platform is provided 202 for transacting the carbon emission reduction currency. The carbon neutrality management platform manages transactions and performs auditing, accounting, greenhouse gas mitigation, and other management activities. The carbon neutrality management platform identifies 202a the carbon emission reduction currency based on its unique identifier. The unique identifier is registered with a custodial registry maintained by the custodial financial institution that issues unique identifiers to the carbon emission reduction credits and reconciles these with the service provider. The custodial financial institution issues and tracks the carbon emission reduction credits, and accepts the carbon emission reduction credits that are retired. The carbon neutrality management platform determines 202b one of the fixed set of denominations of carbon emission reduction credits associated with the identified carbon emission reduction currency. The carbon neutrality management platform also enables 202c an end user to register the end user's purchase and details with the service provider and permanently retire the carbon emission reduction credits associated with the identified carbon emission reduction currency. Furthermore, the carbon neutrality management platform allows the end user to trade the carbon emission reduction currency for an item of value. The carbon neutrality management platform enables purchasing 202d of the carbon emission reduction currency, selling the carbon emission reduction currency, and trading the carbon emission reduction currency for an item of value.

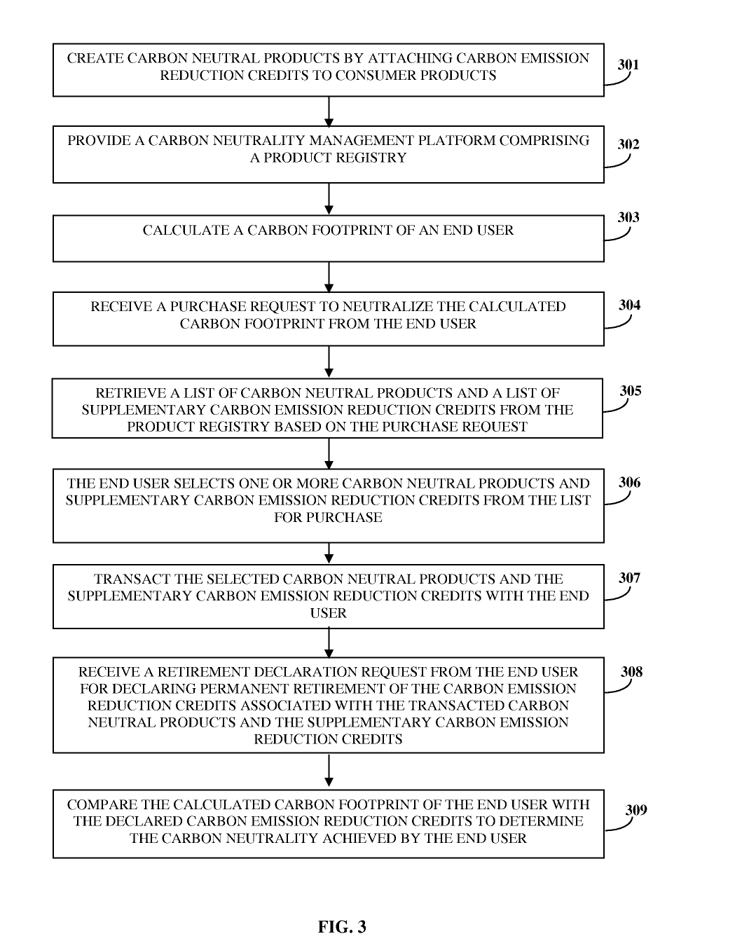

FIG. 3 illustrates a computer implemented method for enabling an end user to achieve carbon neutrality using a carbon neutrality management platform. The end user first registers with the carbon neutrality management platform by providing the end user's details, for example, name, address, contact information, credit card information, etc. Carbon neutral products are created 301 by attaching carbon emission reduction credits to consumer products as disclosed in the detailed description of FIG. 1. Each of the carbon neutral products comprises a unique identifier that represents a fixed denomination of carbon emission reduction credits. In addition to the carbon emission reduction credits attached in the carbon neutral products, supplementary carbon emission reduction credits are also generated as disclosed in the detailed description of FIG. 1. The carbon neutrality management platform is provided 302 to the end user for transacting the created carbon neutral products and the supplementary carbon emission reduction credits. The carbon neutrality management platform comprises a product registry that stores a list of the created carbon neutral products available for sale to end users with the unique identifiers and corresponding pre-assigned carbon emission reduction credits and a list of supplementary carbon emission reduction credits. The unique identifiers may, for example, be similar to securities identifiers such as an International Securities Identification Number (ISIN) or a Committee on Uniform Securities Identification Procedures (CUSIP) number. These carbon emission reduction credits may be reconciled with the carbon emission reduction credits in the pre-created carbon credit trading account at the custodial financial institution.

The carbon neutrality management platform calculates 303 a carbon footprint of the end user based on predefined and recognized GHG practices and guidelines. In an embodiment, the computer implemented method herein is used for performing a carbon audit by the carbon neutrality management platform. Consider an example, where an end user wishes to perform a carbon audit. Carbon audit is a process of calculating the carbon footprint of an end user. The calculation takes into account all the CO2 or CO2e emissions generated by the end user and the end user's activities, for example, by determining the sum of the end users total scope 1 GHG emissions, scope 2 GHG emissions, and scope 3 GHG emissions.

The carbon neutrality management platform prompts the end user via a graphical user interface (GUI) to answer a few queries pertaining to the amount of CO2 or CO2e emissions emitted by the end user. The queries are, for example, “how many times have you taken a flight in the last one year?”, “do you have a motor bike?”, etc. The carbon neutrality management platform then evaluates, calculates, determines, and quantifies the size of carbon footprint of the end user, in terms of CO2e emitted into the atmosphere by the end user and end user's activities, based on the answers the end user provided to the queries generated by the carbon neutrality management platform.

The carbon neutrality management platform then prompts the end user to purchase one or more of the carbon neutral products and the supplementary carbon emission reduction credits for offsetting the total amount of CO2 or CO2e emissions identified by the carbon neutrality management platform and emitted by the end user and the end user's activities. The carbon neutrality management platform retrieves the list of carbon neutral products and the list of the supplementary carbon emission reduction credits available in the product registry and displays the retrieved list on the GUI.

Each of the carbon neutral products and the supplementary carbon emission reduction credits comprises a unique identifier. The end user selects one or more of carbon neutral products and the supplementary carbon emission reduction credits that comprises enough carbon emission reduction credits for offsetting the amount of CO2 or CO2e emissions emitted by the end user and the end user's activities. The carbon neutrality management platform transacts the selected carbon neutral products and the supplementary carbon emission reduction credits with the end user.

The carbon neutrality management platform facilitates transaction of the selected carbon neutral products and the supplementary carbon emission reduction credits by the end user. The carbon neutrality management platform receives 304 a purchase request to neutralize the carbon footprint from the end user. The purchase request is a request invoked by the end user to purchase the carbon neutral products and the supplementary carbon emission reduction credits. The carbon neutrality management platform retrieves 305 the list of carbon neutral products and the list of supplementary carbon emission reduction credits from the product registry based on the purchase request and displays the retrieved list on GUI of the communication device of the end user. The end user selects 306 one or more of the carbon neutral products and the supplementary carbon emission reduction credits from the displayed list of carbon neutral products and the list of supplementary carbon emission reduction credits for purchase. The carbon neutrality management platform transacts 307 the selected carbon neutral products and supplementary carbon emission reduction credits with the end user.

The carbon neutrality management platform then receives 308 a retirement declaration request from the end user for declaring permanent retirement of the carbon emission reduction credits associated with the transacted carbon neutral products and the supplementary carbon emission reduction credits. The end user requests for permanently retiring the carbon emission reduction credits associated with the transacted carbon neutral products and supplementary carbon emission reduction credits using the retirement declaration request. The permanent retirement of the carbon emission reduction credits contained in the retirement declaration request is performed by registering the carbon emission reduction credits associated with the transacted carbon neutral products and the supplementary carbon emission reduction credits in the carbon credit retirement account maintained by the custodial financial institution. The end user may get additional benefits, for example, tax exemption when the end user purchases the carbon emission reduction credits.

The carbon neutrality management platform compares 309 the calculated carbon footprint of the end user with the declared carbon emission reduction credits to determine the carbon neutrality achieved by the end user.

In another embodiment, the carbon neutral products are rechargeable with the supplementary carbon emission reduction credits. Consider an example where an end user has a carbon neutral product with 100 carbon emission reduction credits. The end user wants to calculate their carbon footprint and permanently retire the corresponding amount of carbon emission reduction credits. The carbon neutrality management platform evaluates and calculates the end user's carbon footprint as emitting 150 tonnes of CO2 or CO2e emissions into the atmosphere. The end user may only need to purchase 50 more carbon emission reduction credits since the end user already has purchased only 100 carbon emission reduction credits. Once the end user purchases the 50 carbon emission reduction credits, the end user then may permanently retire up to 150 carbon emission reduction credits or carbon emission reduction offsets towards effectively offsetting the CO2 or CO2e emissions that the end user and the end user's activities have emitted into the atmosphere for the time period covered by the carbon audit, for example, three months, six months or one year, thereby achieving carbon neutrality.

Consider another example where an end user takes a flight from Ottawa to New York. The end user determines that the end user's journey will emit, for example, 3 tonnes of CO2 or CO2e into the atmosphere due to the flight. If the end user wishes to offset the end user's flight, the end user buys a carbon neutral product with 3 carbon emission reduction credits attached and offsets the end user's flight.

Consider another example where an end user purchases a carbon emission reduction credits card at a news stand in an airport with the intention of offsetting the end user's flight. The carbon emission reduction credits card comprises a unique identifier or serial number that represents supplementary carbon emission reduction credits associated with, for example, 5 tonnes of carbon emission reductions to offset the end user's flight. The end user contacts the service provider via, for example, a telephone or a personal digital assistant and calculates the carbon footprint of that flight. The end user then registers the purchase and details with the service provider and presents the service provider with a retirement declaration request, to permanently retire the carbon emission reduction credits representing 5 tonnes of CO2 or CO2e emission reductions, associated with the purchase of the carbon emission reduction credits card which represents 5 tonnes of CO2 or CO2e emission reductions, thereby offsetting the end user's flight activities. This transaction will always be attributed to that end user and the profile of the end user will be created in the database of the service provider, which allows the end user to make additional purchases to offset carbon contributed by the activities of the end user at a later point in time. The end user may also be reminded of the carbon footprint not covered by retirement of these carbon emission reduction credits.

In another embodiment, a toll free phone number and a website address is provided in association with the carbon neutrality management platform. An end user calls the toll free phone number or registers the details of their purchase with the service provider via, for example, the internet. The end user also provides the service provider with end user contact details for establishing a profile account. The end user details are, for example, name of the end user, telephone number of the end user, one or more electronic mail (email) addresses of the end user, contact address details of the end user, information of carbon emission reduction credits that have been purchased, etc. The end user registers the unique identifiers of the carbon emission reduction credits that have been purchased and may also issue a retirement declaration request for permanently retiring the carbon emission reduction credits associated with the carbon neutral product.

In another embodiment, the toll free number is provided on the carbon neutral product. For example, the plush toy “Save The Planet Sammy” is a carbon neutral product sold with a medallion, a token, a badge or a detachable wristband with a unique identifier such as a serial number that is attached to the plush toy. The attachment signifies that a purchaser of the plush toy or carbon neutral product has also purchased carbon emission reduction credits. The plush toy is sold with a website address, email details and/or a toll free number to call so the end user may register their purchase with the service provider and issue a retirement declaration request to permanently retire the carbon emission reduction credits associated with the unique identifier purchased with the plush toy. To permanently retire the carbon emission reduction credits, the end user contacts the service provider and then provides the service provider with a retirement declaration request and the end user's details, for example, name, contact details, carbon credit information, etc., and registers the unique serial numbers of the carbon emission reduction credits that the end user has already purchased and permanently retires the carbon emission reduction credits associated with the plush toy.

In another embodiment, the carbon neutrality management platform provides an educational tutorial for creating awareness pertaining to adverse effects of global warming and shows or suggests how to adjust a carbon intense lifestyle to a low carbon lifestyle. For example, one of the online educational tutorials comprises a chapter on climate change caused due to global warming and the name of the chapter is “Care about climate change”. The carbon neutrality management platform may also comprise multiple videos pertaining to climate change that explain and offer guidance on how end users may adapt their carbon intensive behaviors to become more climate aware and as a result adapt mitigation practices in order to achieve carbon neutrality through the purchase of one or more of the carbon neutral products and the supplementary carbon emission reduction credits, thereby totally mitigating their CO2 or CO2e emissions. The carbon neutrality management platform may also provide a forum to end users and climate experts to discuss ongoing and current issues pertaining to climate change and global warming related topics. The issues comprise, for example, energy security, glacier melt, population issues, biodiversity, animal and nature conservation, genetically modified foods, acid rain, extreme weather conditions, sustainable development, etc.

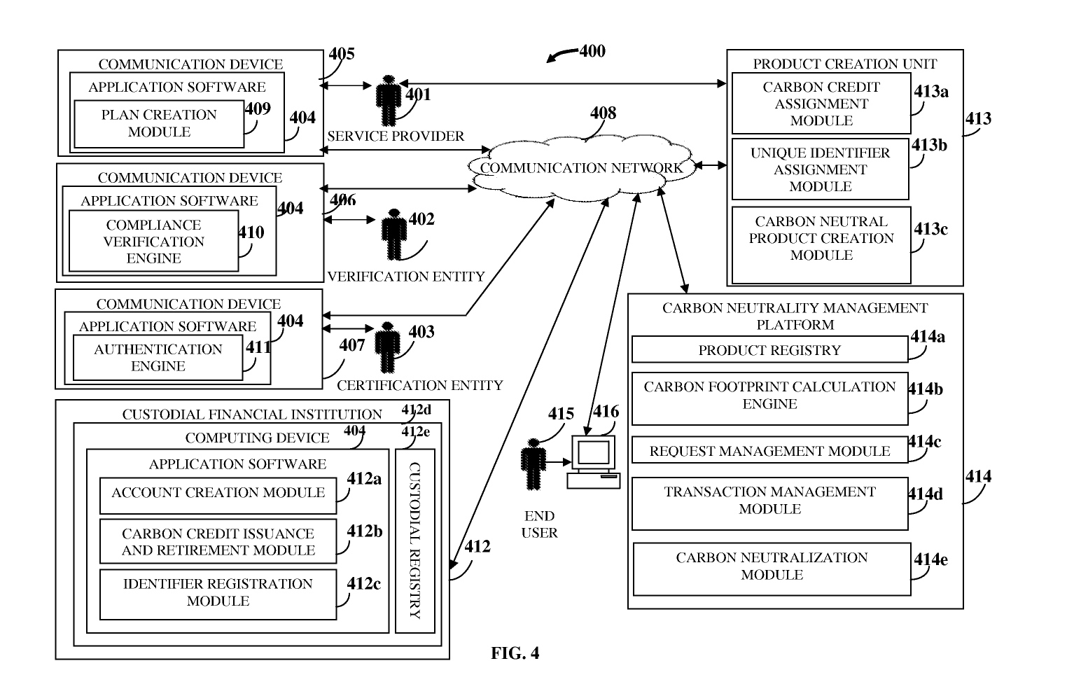

FIG. 4 illustrates a computer implemented system 400 for enabling an end user 415 to achieve carbon neutrality. The computer implemented system 400 disclosed herein comprises an application software 404 provided on each of a service provider's 401 communication device 405, a verification entity's 402 communication device 406, a certification entity's 403 communication device 407, and a custodial financial institution's 412 communication device 412d. The application software 404 on the service provider's 401 communication device 405 comprises a plan creation module 409 that creates a plan for an emission reduction project for generating the carbon emission reduction credits. The plan creation module 409 transmits the created plan to the verification entity's 402 communication device 406 and the certification entity's 403 communication device 407 via a communication network 408.

The application software 404 on the verification entity's 402 communication device 406 comprises a compliance verification engine 410 that verifies compliance of the emission reduction project in the transmitted plan based on accepted standards and generates a verification report. The compliance verification engine 410 transmits the generated verification report to the certification entity's 403 communication device 407 the service provider's 401 communication device 405, and the custodial financial institution's 412 communication device 412d via the communication network 408.

The application software 404 on the certification entity's 403 communication device 407 comprises an authentication engine 411 that authenticates the transmitted verification report based on standardized accepted certification criteria and generates a certification report. The certification report is a carbon unit certification statement. The carbon unit certification statement comprises the amount of carbon emission reduction credits generated by the emission reduction project. The authentication engine 411 transmits the generated certification report and the transmitted verification report to the custodial financial institution's 412 communication device 412d via the communication network 408. The generated certification report ensures compliance of the emission reduction project with the accepted standards and the standardized accepted certification criteria for generating the carbon emission reduction credits that are real, quantifiable, additional, permanent, verified, and certified, and for proving that the service provider 401 is entitled to rights associated with ownership of the carbon emission reduction credits.

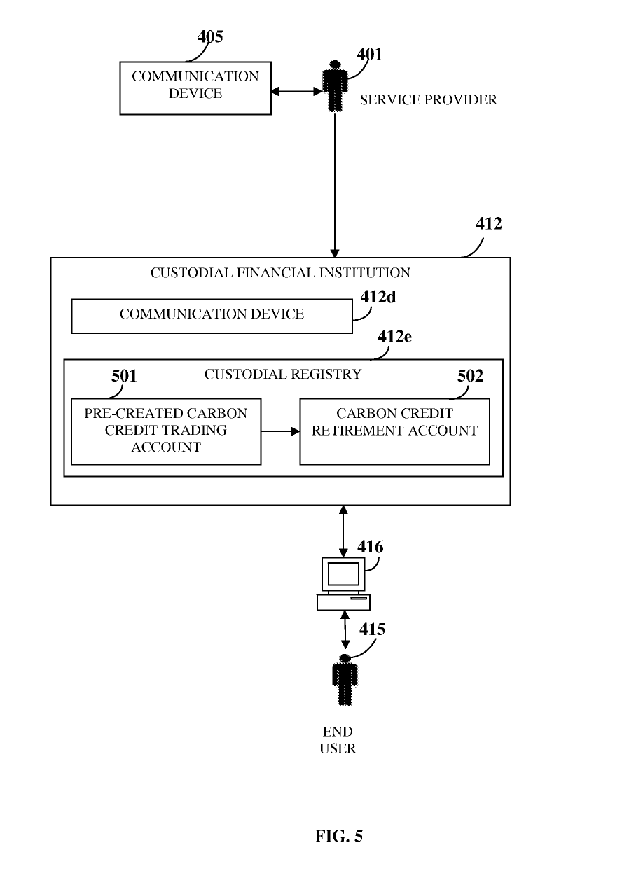

The application software 404 on the custodial financial institution's 412 communication device 412d comprises an account creation module 412a, a carbon credit issuance and retirement module 412b, and an identifier registration module 412c. The account creation module 412a creates a carbon credit trading account 501 and a carbon credit retirement account 502 for the service provider 401 in a custodial registry 412e of the custodial financial institution 412 as exemplarily illustrated in FIG. 5. The carbon credit issuance and retirement module 412b issues the amount of carbon emission reduction credits stated in the carbon unit certification statement and deposits the issued carbon emission reduction credits into the pre-created carbon credit trading account 501 of the service provider 401 based on a review of title documentation, the verification report, and the certification report that ensures sole ownership of the carbon emission reduction credits and any rights associated with the ownership of the carbon emission reduction credits. The carbon credit trading account 501 stores the deposited carbon emission reduction credits. The carbon credit issuance and retirement module 412b also retires the carbon emission reduction credits of an end user 415 permanently from the pre-created carbon credit trading account 501 to the carbon credit retirement account 502. The carbon emission reduction credits are transferred and held in perpetuity in the carbon credit retirement account 502 of the service provider 401 on behalf of the end user's 415 purchase and subsequent registration and retirement declaration by the end user 415 to the service provider 401. The end user 415 permanently retires the carbon emission reduction credits associated with the transacted carbon neutral products and the supplementary carbon emission reduction credits by registering the carbon emission reduction credits in the carbon credit retirement account 502.

The computer implemented system 400 disclosed herein further comprises a product creation unit 413. The product creation unit 413 comprises a carbon credit assignment module 413a, a unique identifier assignment module 413b, and a carbon neutral product creation module 413c. The carbon credit assignment module 413a retrieves the deposited carbon emission reduction credits from the pre-created carbon credit trading account 501 of the service provider 401 and assigns one or more of the retrieved carbon emission reduction credits to one or more consumer products. The carbon neutral product creation module 413c attaches or embeds the assigned carbon emission reduction credits to the consumer products to create carbon neutral products. The unique identifier assignment module 413b assigns a unique identifier to each of the created carbon neutral products. The unique identifier assignment module 413b also assigns unique identifiers to the remaining carbon emission reduction credits available in the pre-created carbon credit trading account 501 of the service provider 401 to create supplementary carbon emission reduction credits. The service provider 401 registers the created carbon neutral products and the supplementary carbon emission reduction credits with the custodial financial institution 412 using the identifier registration module 412c operated by the custodial financial institution 412.

The computer implemented system 400 disclosed herein further comprises a carbon neutrality management platform 414 in communication with the product creation unit 413 and the custodial financial institution 412 via the communication network 408. The carbon neutrality management platform 414 comprises a product registry 414a, a carbon footprint calculation engine 414b, a request management module 414c, a transaction management module 414d, and a carbon neutralization module 414e. The product registry 414a stores a list of the created carbon neutral products and a list of supplementary carbon emission reduction credits. An end user 415 accesses the carbon neutrality management platform 414 using a communication device 416, for example, a personal computer, a laptop, a mobile phone, a personal digital assistant, etc. via the communication network 408. The carbon footprint calculation engine 414b calculates the carbon footprint of the end user 415 and generates an audit trail. The end user 415 uses the request management module 414c to invoke a purchase request to neutralize the calculated carbon footprint. The purchase request is a request invoked by the end user 415 to purchase one or more of the carbon neutral products and the supplementary carbon emission reduction credits. The request management module 414c receives the purchase request and retrieves the list of carbon neutral products and the list of the supplementary carbon emission reduction credits from the product registry 414a based on the purchase request. The transaction management module 414d enables the end user 415 to select one of the carbon neutral products and the supplementary carbon emission reduction credits from the displayed list of carbon neutral products and the list of supplementary carbon emission reduction credits for purchase. The transaction management module 414d transacts the selected carbon neutral products and the supplementary carbon emission reduction credits with the end user 415.

The end user 415 then uses the request management module 414c to invoke a retirement declaration request for declaring the permanent retirement of the carbon emission reduction credits associated with the transacted carbon neutral products and the supplementary carbon emission reduction credits. The end user 415 submits the end user's 415 details and the retirement declaration request for the end user 415 permanently retires the carbon emission reduction credits associated with the transacted carbon neutral products in the service provider's 401 carbon credit retirement account 502 maintained by the custodial financial institution 412.

The carbon neutralization module 414e compares the calculated carbon footprint of the end user 415 with the declared carbon emission reduction credits to determine the carbon neutrality achieved by the end user 415.

FIG. 5 illustrates a process of generation and retirement of carbon emission reduction credits by a service provider 401. The service provider 401 generates carbon emission reduction credits after the emission reduction project is verified and a certification report is transmitted to the communication device 412d of the custodial financial institution 412. The certification report ensures that the carbon emission reduction credits generated by the service provider 401 are real, quantifiable, additional, permanent, verified, and certified in accordance and compliance with acceptable standards. The custodial financial institution 412 checks all the documentation pertaining to these carbon emission reduction credits and when satisfied, the carbon emission reduction credits are deposited into a pre-created carbon credit trading account 501 of the service provider 401. The pre-created carbon credit trading account 501 is held in the custodial registry 412e of the custodial financial institution 412. Furthermore, the carbon emission reduction credits may be withdrawn from the pre-created carbon credit trading account 501. The pre-created carbon credit trading account 501 is used by the service provider 401 to buy and sell the carbon emission reduction credits using the communication device 405. The service provider 401 may create carbon neutral products by attaching the carbon emission reduction credits deposited at the pre-created carbon credit trading account 501 to consumer products. The service provider 401 may register the carbon neutral products and the supplementary carbon emission reduction credits using unique identifiers for reconciliation of all carbon emission reduction credits with the custodial financial institution 412.

An end user 415 may purchase the created carbon neutral products via the carbon neutrality management platform 414 to reduce their carbon footprint and achieve carbon neutrality. The end user 415 may also obtain supplementary carbon emission reduction credits from the service provider 401 via the carbon neutrality management platform 414. The end user 415 provides details for registering at the carbon neutrality management platform 414, prior to the purchase of the carbon neutral products and the supplementary carbon emission reduction credits. Upon usage, the end user 415 may send a retirement declaration request to the service provider 401. The service provider 401 may send the retirement declaration request to the carbon neutrality management platform 414 for declaring the permanent retirement of the carbon emission reduction credits associated with the carbon neutral products and the supplementary carbon emission reduction credits. The service provider 401 also maintains a carbon credit retirement account 502 in the custodial registry 412e of the custodial financial institution 412. Using the carbon credit retirement account 502, the carbon emission reduction credits can be permanently retired after use by the end user 415 and when the end user 415 directs the carbon emission reduction credits to be permanently retired. As used herein, permanent retirement of the carbon emission reduction credits by the end user 415 means that the end user 415 has exhausted the carbon emission reduction credits and accordingly, the permanently retired carbon emission reduction credits are not reusable and the rights of ownership are extinguished.

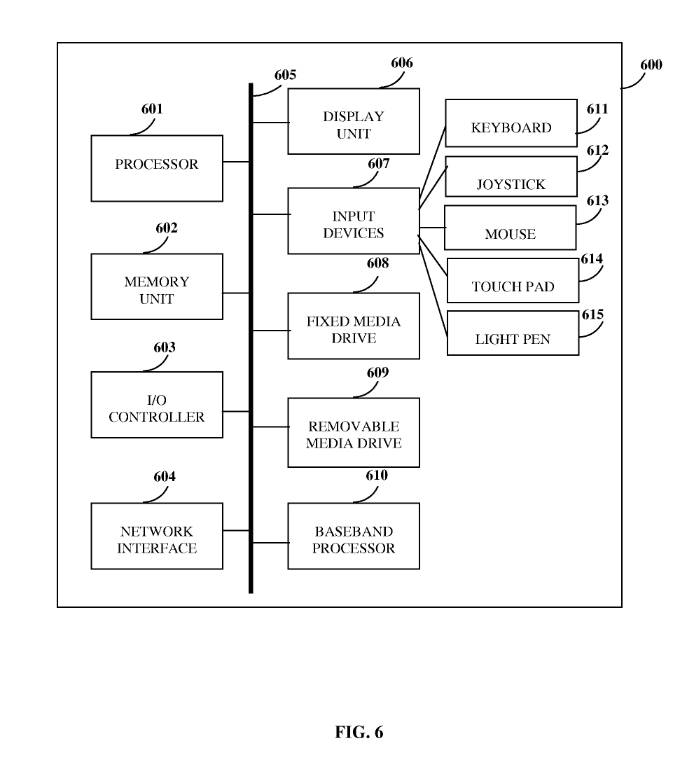

FIG. 6 exemplarily illustrates the architecture of a computer system 600 employed on the carbon neutrality management platform 414 and the communication devices 405, 406, 407, and 412d of the service provider 401, the verification entity 402, the certification entity 403, and the custodial financial institution 412 respectively for enabling an end user 415 to achieve carbon neutrality. The application software 404 disclosed in the detailed description of FIG. 1 is deployed on, for example, the computer system 600 of the communication devices 405, 406, 407, and 412d of the service provider 401, the verification entity 402, the certification entity 403, and the custodial financial institution 412 respectively.

The communication devices 405, 406, 407, 412d, and 416 of the service provider 401, the verification entity 402, the certification entity 403, the custodial financial institution 412, and the end user 415 respectively communicate with each other via the communication network 408. The communication network 408 is, for example, a local area network (LAN), a wide area network (WAN), a cellular network, a satellite network, etc. The computer system 600 comprises, for example, a processor 601, a memory unit 602 for storing programs and data, an input/output (I/O) controller 603, a network interface 604, a network bus 605, a display unit 606, input devices 607, a fixed media drive 608, a removable media drive 609, a baseband processor 610, etc.

The processor 601 is an electronic circuit that executes computer programs. The memory unit 602 is used for storing programs and applications. The application software 404 is, for example, stored on the memory unit 602 of the computer system 600. The memory unit 602 is, for example, a random access memory (RAM) or another type of dynamic storage device that stores information and instructions for execution by the processor 601. The memory unit 602 also stores temporary variables and other intermediate information used during execution of the instructions by the processor 601. The computer system 600 further comprises a read only memory (ROM) or another type of static storage device that stores static information and instructions for the processor 601. The network interface 604 enables connection of the computer system 600 to the communication network 408. In case of a mobile computing device, the network interface 604 connects the computing device wirelessly to the communication network 408. The mobile computing device further comprises a baseband processor 610 for processing communication functions and managing communication transactions with the communication network 408. The I/O controller 603 controls the input and output actions performed by the service provider 401, the verification entity 402, and the certification entity 403, and the end user 415. The network bus 605 permits communication between the modules of the application software 404 and the modules of the carbon neutrality management platform 414.

The display unit 606 displays computed results to the service provider 401, the verification entity 402, the certification entity 403, the custodial financial institution 412, and the end user 415. The input devices 607 are used for inputting data into the computer system 600. The input devices 607 are, for example, a keyboard 611 such as an alphanumeric keyboard, a joystick 612, a mouse 613, a touch pad 614, a light pen 615, etc. The computer system 600 further comprises a fixed media drive 608 and a removable media drive 609 for receiving removable media.

Computer applications and programs are used for operating the computer system 600. The programs are loaded onto the fixed media drive 608 and into the memory unit 602 of the computer system 600 via the removable media drive 609. In an embodiment, the computer applications and programs may be loaded directly through the communication network 408. Computer applications and programs are executed by double clicking a related icon displayed on the display unit 606 using one of the input devices 607. The service provider 401, the verification entity 402, the certification entity 403, and the end user 415 interact with the computer system 600 using a graphical user interface (GUI) of the display unit 606.

The computer system 600 employed on the communication devices 405, 406, 407, and 412d of the service provider 401, the verification entity 402, the certification entity 403, and the custodial financial institution 412 respectively, employs operating systems for performing multiple tasks. An operating system is responsible for the management and coordination of activities and the sharing of the resources of the computer system 600. The operating system further manages security of the computer system 600, peripheral devices connected to the computer system 600, and network connections. The operating system employed on the computer system 600 recognizes, for example, inputs provided by the service provider 401, the verification entity 402, the certification entity 403, and the end user 415 using one of the input devices 607, the output display, files and directories stored locally on the fixed media drive 608, etc. The operating system on each computer system 600 executes different programs initiated by the service provider 401, the verification entity 402, the certification entity 403, and the custodial financial institution 412 using the processor 601. Instructions for executing the application software 404 are retrieved by the processor 601 from the program memory in the form of signals. The location of the instructions in the program memory is determined by a program counter (PC). The program counter stores a number that identifies the current position in the program of the application software 404.

The instructions fetched by the processor 601 from the program memory after being processed are decoded. After processing and decoding, the processor 601 executes the instructions. For example, the plan creation module 409 defines instructions for creating a plan for an emission reduction project that generates carbon emission reduction credits, the compliance verification engine 410 defines instructions for verifying compliance of the emission reduction project based on accepted standards and generating a verification report, and the authentication engine 411 defines instructions for authenticating the verification report based on standardized accepted certification criteria and generating a certification report. The account creation module 412a defines instructions for creating a carbon credit trading account 501 and a carbon credit retirement account 502 for the service provider 401. The carbon credit issuance and retirement module 412b defines instructions for issuing the amount of carbon emission reduction credits as stated in the certification report corresponding to the emission reduction project and depositing the issued carbon emission reduction credits in the pre-created carbon credit trading account 501 of the service provider 401. The carbon credit issuance and retirement module 412b also defines instructions for permanently retiring the carbon emission reduction credits from the pre-created carbon credit trading account 501 to the carbon credit retirement account 502. The identifier registration module 412c defines instructions for registering the carbon neutral products and the supplementary carbon emission reduction credits with the custodial financial institution 412. The carbon footprint calculation engine 414b defines instructions for calculating the carbon footprint of the end user 415. The request management module 414c defines instructions for receiving a purchase request and a retirement declaration request from the end user 415. The request management module 414c defines instructions for retrieving the list of carbon neutral products from the product registry 414a based on the purchase request, the transaction management module 414d defines instructions for transacting the selected carbon neutral products with the end user 415, and the carbon neutralization module 414e defines instructions for comparing the calculated carbon footprint of the end user 415 with the declared carbon emission reduction credits to determine the carbon neutrality achieved by the end user 415.

The processor 601 on each of the service provider's 401 communication device 405, the verification entity's 402 communication device 406, the certification entity's 403 communication device 407, and the custodial financial institution's 412 communication device 412d retrieves the instructions defined by the plan creation module 409, the compliance verification engine 410, and the authentication engine 411 respectively and executes them. The processor 601 on the custodial financial institution's 412 communication device 412d retrieves the instructions defined by the account creation module 412a, the carbon credit issuance and retirement module 412b, and the identifier registration module 412c and executes them. Furthermore, the processor 601 on the carbon neutrality management platform 414 retrieves the instructions defined by the carbon footprint calculation engine 414b, the request management module 414c, the transaction management module 414d, the carbon neutralization module 414e, etc. and executes the instructions.

For purposes of illustration, the detailed description refers to the application software 404 being run locally on a computer system 600; however the scope of the computer implemented method and system 400 disclosed herein is not limited to the application software 404 being run locally on a computer system 600 via the operating system and the processor 601 but may be extended to run remotely over the communication network 408 by employing a web browser and remote server, mobile phone, or other electronic devices. The mobile phones, for example, comprise BlackBerry® of Research In Motion Limited, iPhone® of Apple Inc., personal digital assistants, smart phones, etc. employing mobile operating systems. The mobile operating systems employed, for example, comprise Android® mobile operating system of Google Inc, etc.

It will be readily apparent that the various methods and algorithms described herein may be implemented in a computer readable medium appropriately programmed for general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. The computer readable media has stored thereon multiple sequences of instructions which, when executed by a processor, cause the processor to perform the method disclosed herein. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer readable medium” refers to any medium that participates in providing data, for example instructions that may be read by a computer, a processor or a like device. Such a medium may take many forms, including but not limited to, non-volatile media, volatile media, and transmission media. Non volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Common forms of computer readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer readable programs may be implemented in any programming language. Some examples of languages that can be used include C, C++, C#, Python, or JAVA. The software programs may be stored on or in one or more mediums as an object code. A computer program product comprising computer executable instructions embodied in a computer readable medium comprises computer parsable codes for the implementation of the processes of various embodiments.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method for creating carbon neutral products, comprising:
providing an application software on a communication device of each of a service provider, a verification entity, a certification entity, and a custodial financial institution;
creating a plan for an emission reduction project for generating carbon emission reduction credits by said service provider using said application software;
verifying compliance of said emission reduction project based on accepted standards by said verification entity using said application software and generating a verification report, wherein said verification report is transmitted to said communication device of each of said certification entity, said service provider, and said custodial financial institution;
authenticating said verification report based on standardized accepted certification criteria by said certification entity using said application software and generating a certification report, wherein said certification report is transmitted to said communication device of said custodial financial institution, and wherein generation of said certification report based on said authentication ensures compliance of said emission reduction project with said accepted standards and said standardized accepted certification criteria for generating said carbon emission reduction credits that are real, quantifiable, additional, permanent, verified, and certified, and for proving that said service provider is entitled to rights associated with ownership of said carbon emission reduction credits;
depositing said carbon emission reduction credits into a pre-created carbon credit trading account of said service provider maintained by said custodial financial institution based on a review of title documentation, said verification report, and said certification report that ensures sole ownership of said carbon emission reduction credits and any rights associated with said ownership of said carbon emission reduction credits; and
assigning said carbon emission reduction credits available in said pre-created carbon credit trading account of said service provider to one or more consumer products by said service provider to create said carbon neutral products.

2. The computer implemented method of claim 1, wherein each of said carbon neutral products comprises a unique identifier that represents a fixed denomination of said assigned carbon emission reduction credits.

3. The computer implemented method of claim 2, wherein said service provider and said custodial financial institution reconciles said carbon neutral products with said assigned carbon emission reduction credits using said unique identifier.

4. The computer implemented method of claim 1, wherein said service provider assigns unique identifiers to one or more of remaining carbon emission reduction credits available in said pre-created carbon credit trading account of said service provider to create supplementary carbon emission reduction credits.

5. The computer implemented method of claim 4, further comprising registering said carbon neutral products and said supplementary carbon emission reduction credits using said unique identifiers by said service provider for reconciliation of said assigned carbon emission reduction credits with said custodial financial institution.

6. The computer implemented method of claim 4, further comprising enabling an end user that purchases one or more of said created carbon neutral products and said supplementary carbon emission reduction credits to permanently retire said assigned carbon emission reduction credits using said unique identifiers associated with said purchased one or more carbon neutral products and said supplementary carbon emission reduction credits.

7. The computer implemented method of claim 1, wherein said service provider is entitled to title, rights, and ownership of said generated carbon emission reduction credits, wherein said title, said rights, and said ownership of said generated carbon emission reduction credits by said service provider is verified by said verification entity, certified by said certification entity, and reviewed by said custodial financial institution.

8. The computer implemented method of claim 1, wherein said accepted standards are greenhouse gas mitigation standards that demonstrate that said carbon emission reduction credits held in a custodial registry maintained by said custodial financial institution are real, permanent, quantifiable, verified, certified, and additional.

9. A computer implemented method for enabling an end user to achieve carbon neutrality, comprising:
creating carbon neutral products by attaching carbon emission reduction credits to consumer products, wherein each of said carbon neutral products comprises a unique identifier that represents a fixed denomination of said carbon emission reduction credits;
providing a carbon neutrality management platform for transacting said created carbon neutral products and supplementary carbon emission reduction credits, wherein said carbon neutrality management platform comprises a product registry comprising a list of said created carbon neutral products with assigned carbon emission reduction credits and a list of said supplementary carbon emission reduction credits with said unique identifiers;
calculating a carbon footprint of said end user by said carbon neutrality management platform;
receiving a purchase request to neutralize said calculated carbon footprint from said end user by said carbon neutrality management platform and retrieving one or more of said list of carbon neutral products and said list of said supplementary carbon emission reduction credits from said product registry based on said purchase request;
selecting one or more of said carbon neutral products and said supplementary carbon emission reduction credits from said list of carbon neutral products and said list of supplementary carbon emission reduction credits for purchase by said end user;
transacting said selected one or more carbon neutral products and said supplementary carbon emission reduction credits with said end user on said carbon neutrality management platform;
receiving a retirement declaration request from said end user by said carbon neutrality management platform for declaring permanent retirement of said carbon emission reduction credits associated with said transacted carbon neutral products and said supplementary carbon emission reduction credits; and
comparing said calculated carbon footprint of said end user with said declared carbon emission reduction credits by said carbon neutrality management platform for determining said carbon neutrality achieved by said end user.

10. The computer implemented method of claim 9, further comprising registering said end user on said carbon neutrality management platform.

11. The computer implemented method of claim 9, wherein said permanent retirement of said carbon emission reduction credits is performed by registering said carbon emission reduction credits associated with said transacted carbon neutral products and said supplementary carbon emission reduction credits with a carbon credit retirement account maintained by a custodial financial institution.

12. A method of transacting carbon emission reduction credits, comprising:
creating a carbon emission reduction currency represented by one or more carbon neutral products and supplementary carbon emission reduction credits, said carbon emission reduction currency having a unique identifier, wherein said carbon emission reduction currency represents one of a fixed set of denominations of carbon emission reduction credits;
said carbon emission reduction currency being associated with a secondary function;
providing a carbon neutrality management platform that performs the steps of:
identifying said carbon emission reduction currency based on said unique identifier;
determining one of said fixed set of denominations of carbon emission reduction credits associated with said identified carbon emission reduction currency; and
enabling said end user to permanently retire said determined carbon emission reduction credits associated with said identified carbon emission reduction currency on said carbon neutrality management platform.

13. The method of claim 12, wherein said unique identifier is registered with a custodial financial institution that issues and tracks said carbon emission reduction credits, and accepts said carbon emission reduction credits that are retired.

14. The method of claim 12, wherein said carbon emission reduction currency is created by associating each of a plurality of consumer products with a fixed denomination of said carbon emission reduction credits.

15. The method of claim 12, wherein said secondary function of said carbon emission reduction currency is associated with one or more utilities.

16. The method of claim 12, wherein said carbon neutrality management platform enables purchasing of said carbon emission reduction currency, selling said carbon emission reduction currency, and trading said carbon emission reduction currency for an item of value.

17. The method of claim 12, wherein said unique identifier is displayed on said carbon emission reduction currency.

18. A computer implemented system for enabling an end user to achieve carbon neutrality, comprising:
an application software on a communication device of each of a service provider, a verification entity, a certification entity, and a custodial financial institution;
said application software on said communication device of said service provider, comprising a plan creation module that creates a plan for an emission reduction project that generates carbon emission reduction credits, wherein said plan creation module transmits said created plan to said communication device of said verification entity and said communication device of said certification entity via a communication network;
said application software on said communication device of said verification entity, comprising a compliance verification engine that verifies compliance of said emission reduction project in said transmitted plan based on accepted standards and generates a verification report, wherein said compliance verification engine transmits said generated verification report to said communication device of each of said certification entity, said service provider, and said custodial financial institution via said communication network;
said application software on said communication device of said certification entity, comprising an authentication engine that authenticates said transmitted verification report based on standardized accepted certification criteria and generates a certification report, wherein said authentication engine transmits said certification report to said communication device of said custodial financial institution via said communication network, and wherein said generated certification report ensures compliance of said emission reduction project with said accepted standards and said standardized accepted certification criteria for generating said carbon emission reduction credits that are real, quantifiable, additional, permanent, verified, and certified, and for proving that said service provider is entitled to rights associated with ownership of said carbon emission reduction credits;
a carbon credit issuance and retirement module operated by said custodial financial institution, wherein said carbon credit issuance and retirement module issues carbon emission reduction credits and deposits said issued carbon emission reduction credits into a pre-created carbon credit trading account of said service provider maintained by said custodial financial institution based on a review of title documentation, said verification report, and said certification report that ensures sole ownership of said carbon emission reduction credits and any rights associated with said ownership of said carbon emission reduction credits;
a carbon credit assignment module operated by a product creation unit of said service provider, wherein said carbon credit assignment module retrieves said deposited carbon emission reduction credits from said pre-created carbon credit trading account of said service provider and assigns said retrieved carbon emission reduction credits to one or more consumer products;
a carbon neutral product creation module operated by said product creation unit, wherein said carbon neutral product creation module attaches said assigned carbon emission reduction credits to said one or more consumer products to create said carbon neutral products;
a carbon neutrality management platform in communication with said product creation unit and said custodial financial institution via said communication network, comprising:
a carbon footprint calculation engine that calculates a carbon footprint of said end user;
a transaction management module that enables said end user to transact carbon neutral products and supplementary carbon emission reduction credits selected by said end user from a product registry; and
a carbon neutralization module that compares said calculated carbon footprint of said end user with said carbon emission reduction credits associated with said transacted carbon neutral products and said supplementary carbon emission reduction credits declared by said end user to determine said carbon neutrality achieved by said end user.

19. The computer implemented system of claim 18, further comprising an account creation module operated by said custodial financial institution, wherein said account creation module creates said carbon credit trading account for said service provider, wherein said carbon credit trading account stores said deposited carbon emission reduction credits.

20. The computer implemented system of claim 19, wherein said account creation module creates a carbon credit retirement account for said service provider, wherein said end user permanently retires said carbon emission reduction credits associated with said transacted carbon neutral products and said supplementary carbon emission reduction credits by registering said carbon emission reduction credits in said carbon credit retirement account.

21. The computer implemented system of claim 18, further comprising an unique identifier assignment module operated by said product creation unit, wherein said unique identifier assignment module assigns unique identifiers to said created carbon neutral products and said supplementary carbon emission reduction credits retrieved from said carbon credit trading account of said service provider.

22. The computer implemented system of claim 18, further comprising an identifier registration module operated by said custodial financial institution, wherein said identifier registration module enables said service provider to register said created carbon neutral products and said supplementary carbon emission reduction credits with said custodial financial institution using unique identifiers.

23. The computer implemented system of claim 18, wherein said product registry stores a list of said created carbon neutral products and a list of said supplementary carbon emission reduction credits.

24. The computer implemented system of claim 18, wherein said carbon neutrality management platform further comprises a request management module that receives a purchase request to neutralize said calculated carbon footprint from said end user, and wherein said request management module receives a retirement declaration request from said end user for declaring permanent retirement of said carbon emission reduction credits associated with said transacted carbon neutral products and said supplementary carbon emission reduction credits.

25. A computer program product comprising computer executable instructions embodied in a computer readable storage medium, wherein said computer program product comprises:
a first computer parsable program code for calculating a carbon footprint of an end user;
a second computer parsable program code for receiving a purchase request to neutralize said calculated carbon footprint from said end user and retrieving a list of carbon neutral products and a list of supplementary carbon emission reduction credits from a product registry based on said purchase request;
a third computer parsable program code for transacting selected carbon neutral products and said supplementary carbon emission reduction credits with said end user on said carbon neutrality management platform;
a fourth computer parsable program code for receiving a retirement declaration request from said end user by said carbon neutrality management platform for declaring permanent retirement of said carbon emission reduction credits associated with said transacted carbon neutral products and said supplementary carbon emission reduction credits;
a fifth computer parsable program code for comparing said calculated carbon footprint of said end user with said declared carbon emission reduction credits by said carbon neutrality management platform to determine said carbon neutrality achieved by said end user; and
a sixth computer parsable program code for receiving a retirement declaration request from said end user by said carbon neutrality management platform through said service provider for declaring permanent retirement of said carbon emission reduction credits associated with said transacted carbon neutral products and said supplementary carbon emission reduction credits.
